(19) United States
(12) Patent Application Publication
(10) Pub. No.: US 2026/0141304 A1
(43) Pub. Date: May 21, 2026

(54) ARTIFICIAL INTELLIGENCE-BASED SYSTEM AND METHOD FOR CONTEXTUAL CONTENT DELIVERY

(71) Applicant: Phoenix Rising AI LLC, Winter Haven, FL (US)

(72) Inventors: Jonathan Davis, Winter Haven, FL (US); Krishan Kant, Bhartiya City (IN)

(21) Appl. No.: 19/389,257

(22) Filed: Nov. 14, 2025

Related U.S. Application Data
(60) Provisional application No. 63/721,105, filed on Nov. 15, 2024.

(51) Int. Cl. G06N 20/00; G06F 40/30; G10L 15/26

(52) U.S. Cl. CPC G06N 20/00; G06F 40/30; G10L 15/26

(57) ABSTRACT

An artificial intelligence-based system for contextual content delivery includes a server configured to provide, via a user device, a contextually aware user interface. The server is also configured to determine, via input device(s), user interaction event(s) corresponding to the contextually aware user interface. Further, the server is configured to determine, via a model, a context associated with determined user interaction event(s). In addition, the server is configured to generate and/or identify, via the model, contextual content(s) and response(s) of different media types associated with the determined user interaction event(s) based on the determined context. Further, the server is also configured to manipulate, via the model, the contextually aware user interface and provide, via the manipulated contextually aware user interface, the generated and/or identified contextual content(s) and response(s).

### CROSS-REFERENCE TO RELATED APPLICATIONS

The present application claims priority under 35 U.S.C. § 119(e) to U.S. Provisional Patent Application No. 63/721,105, titled “Interactive Chat with Website Takeover” filed Nov. 15, 2024, the disclosure of which is herein incorporated by reference in its entirety.

### BACKGROUND OF THE INVENTION

Typically, interactions involving artificial intelligence-based systems are reciprocal interactions in which generative outputs are provided in response to user inputs. Such interactions are generally text-based, not easily conveyed or understood, and limited to predefined capabilities of artificial intelligence models implemented to enable such interactions. Further, such interactions are also limited to simple two-way communication of information. Conducting complex technical operations requiring expertise are generally beyond scope of conventional interaction platforms involving the artificial intelligence-based systems. Further, such conventional interaction platforms also tend to rely on and incorporate conventional user interface elements including, but not limited to, windows, icons, menus, and pull-down lists that are visually constrained on a display, hard to navigate, time consuming to locate, and designed to provide limited pre-stored static information.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates an environment employing an exemplary artificial intelligence-based system for contextual content delivery, in accordance with some embodiments;

FIG. 2 illustrates a schematic block diagram of an exemplary server included in the exemplary system of FIG. 1, in accordance with some embodiments;

FIG. 3 illustrates an exemplary flowchart for training, updating, modifying, and/or optimizing an artificial intelligence model provided in the exemplary server of FIG. 2, in accordance with some embodiments;

FIG. 4 illustrates a schematic block diagram of an exemplary user device included in the exemplary system of FIG. 1, in accordance with some embodiments;

FIG. 5 illustrates a schematic block diagram of an exemplary input device included in the exemplary system of FIG. 1, in accordance with some embodiments;

FIG. 6 illustrates a schematic block diagram of an exemplary output device included in the exemplary system of FIG. 1, in accordance with some embodiments;

FIG. 7 is a flowchart of an exemplary method implemented by the exemplary system of FIG. 1 for contextual content delivery, in accordance with some embodiments;

FIGS. 8 and 9 are illustrations of an exemplary website interface provided on the exemplary user device of FIGS. 1 and 4, in accordance with some embodiments;

FIGS. 10 and 11 are illustrations of an exemplary web/online chat interface provided on the exemplary user device of FIGS. 1 and 4, in accordance with some embodiments;

FIGS. 12 and 13 are illustrations of an exemplary social communication interface provided on the exemplary user device of FIGS. 1 and 4, in accordance with some embodiments; and

FIGS. 14 and 15 are illustrations of an exemplary search interface provided on the exemplary user device of FIGS. 1 and 4, in accordance with some embodiments.

Skilled artisans will appreciate that elements in the figures are illustrated for simplicity and clarity and have not necessarily been drawn to scale. For example, the dimensions of some of the elements in the figures can be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In one aspect, an artificial intelligence-based system for contextual content delivery is disclosed. The artificial intelligence-based system includes at least one input device, at least one user device, and a server in communication with the at least one device and the at least one user device. The server includes a processor and a memory for storing instructions, that when executed by the processor, causes the server to provide, via the at least one user device, a contextually aware user interface. The server is also configured to determine, via the at least one input device, at least one user interaction event corresponding to the contextually aware user interface. Further, the server is configured to determine, via at least one artificial intelligence model, a context associated with at least one determined user interaction event. In addition, the server is configured to generate and/or identify, via the at least one artificial intelligence model, at least one contextual content and at least one contextual response corresponding to the at least one at least one determined user interaction event based on the determined context. In some embodiments, a media type of the at least one generated and/or identified contextual content and response is different from each other. The server is also configured to manipulate, via the artificial intelligence model, the contextually aware user interface to provide the at least one generated and/or identified contextual content and response. Further, the server is configured to provide, via the manipulated contextually aware user interface, the at least one generated or identified contextual content and response. The at least one user device is configured to detect, via the at least one input device, the at least one user interaction event corresponding to the contextually aware user interface. The at least one user device is also configured to provide, via a transceiver of the at least one user device, the at least one detected user interaction event to the server. Further, the at least one user device is configured to receive, via the server, the at least one generated and/or identified contextual content and response, and information associated with the manipulated contextually aware user interface. In addition, the at least one user device is configured to provide, via at least one output device of the at least one user device and the manipulated contextually aware user interface, the at least one generated and/or identified contextual content and response based on the received information associated with the manipulated contextually aware user interface.

In another aspect, a method for contextual content delivery is disclosed. The method includes providing, via at least one user device, a contextually aware user interface. The method also includes determining, by a server via the at least one input device, at least one user interaction event corresponding to the contextually aware user interface. Further, the method includes determining, via at least one artificial intelligence model implemented by the server, a context associated with at least one determined user interaction event. In addition, the method includes generating and/or identifying, via the at least one artificial intelligence model, at least one contextual content and response associated with the at least one determined user interaction event based on the determined context. In some embodiments, a media type of the at least one generated response and the at least one identified contextual content is different from each other. Furthermore, the method includes manipulating, via the artificial intelligence model, the contextually aware user interface to provide the at least one generated and/or identified contextual content and response. The method also includes providing, via the manipulated contextually aware user interface, the at least one generated and/or identified contextual content and response.

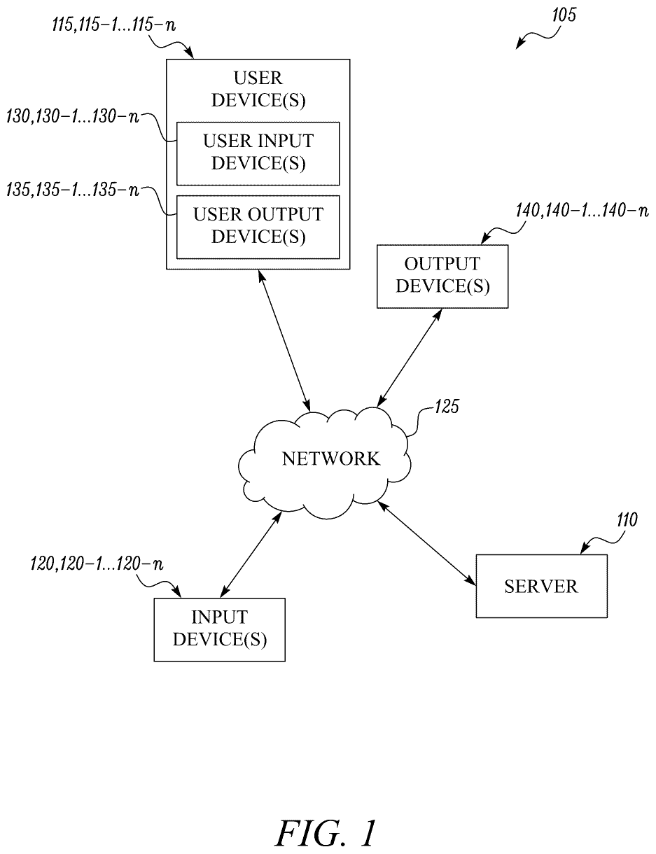

Referring to FIG. 1, an environment including an artificial intelligence-based system 105, herein referred to as the “system 105” for contextual content delivery is disclosed. The system 105 includes a server 110, at least one user device, for example, 115-1 through 115-n, herein referred to as the ‘user device(s) 115’, and at least one input device, for example, 120-1 through 120-n, herein referred to as the ‘input device(s) 120’ in communication with each other via a network 125. In some embodiments, the user device(s) 115 also include at least one user input device, for example, 130-1 through 130-n, herein referred to as ‘user input device(s) 130’ and at least one user output device, for example, 135-1 through 135-n, herein referred to as ‘user output device(s) 135’. In some embodiments, the system 105 also includes at least one output device, for example, 140-1 through 140-n, herein referred to as the ‘output device(s) 140’ independent of and in communication with the user device(s) 115 via the network 125. Examples of the network 125 include, but are not limited to, a Local Area Network (LAN), a Wireless Local Area Network (WLAN), a Small Area Network (SAN), a Wi-Fi Direct Network, a telecommunication network including, but not limited to, a fourth generation (4G) and a fifth generation (5G) cellular network, and any communication network for data communication presently known or in future developed. Examples of the server 110 and/or the user device(s) 115 include, but are not limited to, computers, laptops, mobile devices, handheld devices, personal digital assistants (PDAs), tablet personal computers, digital notebook, wearables, Augmented Reality (AR) devices, Virtual Reality (VR) devices, Mixed Reality (MR) devices, Extended Reality (XR) devices, and other electronic devices now known or in future developed. Examples of input device(s) 120 and/or the user input device(s) 130 include, but are not limited to, a microphone, a camera, a keyboard, a joystick, or any other device capable of capturing an audio, a video, an audio-visual data or any other input device/mechanism presently known or in future developed and providing the captured data to the user device(s) 115 and/or the server 110. Examples of the user output device(s) 135 and/or the output device(s) 140 include, but are not limited to, wired or wireless speakers, wired or wireless earphones or headphones, sound cards and/or systems, display screen(s), monitors, projectors, and augmented or virtual reality glasses or devices and other devices presently known or in future developed.

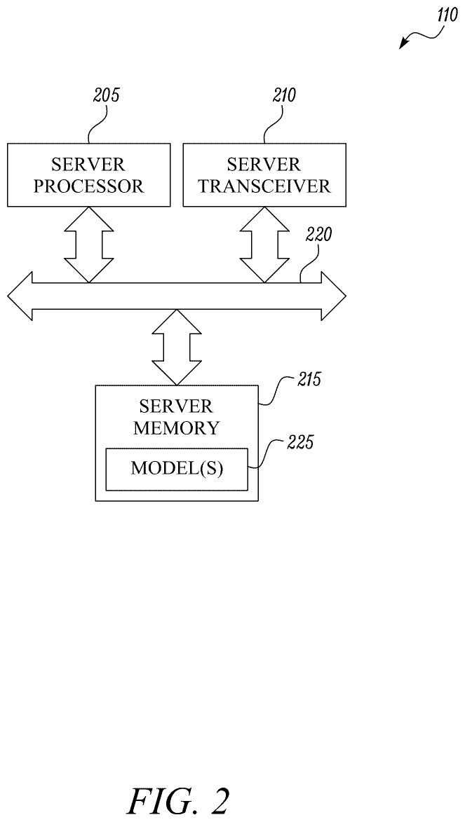

The various components of the server 110 will now be described hereinafter with respect to FIG. 2. It should be appreciated by those of ordinary skill in the art that FIG. 2 depicts the server 110 in a simplified manner and a practical embodiment includes additional components and suitably configured logic to support known or conventional operating features that are not described in detail herein. Although the components of the server 110 are illustrated and described to be implemented within the server 110, it is contemplated that the one or more components of the server 110 can alternatively be implemented in a distributed computing environment and/or implemented to be in remote and/or retrofitted communication with the server 110.

Referring to FIG. 2, the server 110 includes, among other components, a server processor 205, a server transceiver 210, and a server memory 215. The components of the server 110, including the server processor 205, the server transceiver 210, and the server memory 215, cooperate with one another to enable operations of the server 110. The components of the server 110, for example 205, 210, 215, are communicatively coupled via a server local interface 220. The server local interface 220 includes, for example, but is not limited to, one or more buses or other wired or wireless connections, as is now known in the art or in the future developed. In an embodiment, server local interface 220 has additional elements, which are omitted for simplicity, such as controllers, buffers (caches), drivers, repeaters, and receivers, among many others, to enable communications. Further, in some embodiments, the server local interface 220 includes address, control, and/or data connections to enable appropriate communication among the aforementioned components.

As illustrated, the server 110 includes the server transceiver 210 to transmit one or more inputs to and receive one or more outputs from one or more other devices, (as illustrated in FIG. 1) such as, the user device(s) 115, the user input device(s) 130, the input device(s) 120, the user output device(s) 135, and/or the output device(s) 140. The server transceiver 210 includes a transmitter circuitry and a receiver circuitry to enable the server 110 to communicate with the one or more other devices. In this regard, the transmitter circuitry includes appropriate circuitry to transmit the one or more inputs to the one or more other devices, and the receiver circuitry includes appropriate circuitry to receive the one or more outputs from the one or more other devices. It will be appreciated by those of ordinary skill in the art that the server includes a single server transceiver as illustrated, or alternatively separate transmitting and receiving components, for example but not limited to, a transmitter, a transmitting antenna, a receiver, and a receiving antenna.

The server memory 215 is a non-transitory memory configured to store a set of instructions that are executable by the server processor 205 to perform predetermined operations. For example, the server memory 215 includes any of the volatile memory elements (for example, random access memory (RAM)), non-volatile memory elements (for example, read only memory (ROM)), and combinations thereof. Moreover, the server memory 215 incorporates electronic, magnetic, optical, and/or other types of storage media. In some embodiments, the server memory 215 includes at least one network buffer. The at least one network buffer corresponds to temporary storage area in the server memory 215 that holds data when the data is being transferred between electronic devices, for example, the server 110 and the user device(s) 115 to compensate for differences in network speed (data download and/or upload speed) of the server 110 and the user device(s) 115. In accordance with some embodiments, the server memory 215 is also configured to store one or more models 225, herein referred to as the ‘model(s) 225’, including, but not limited to, machine learning, artificial intelligence, logical, and/or conditional modules, algorithms, and/or models including, but not limited to, heuristic models, linear programming models, stochastic models, reinforcement learning models, simulation models, and historical analysis models. In accordance with various embodiments, the model(s) 225 is capable of processing and understanding the data associated with one or more user devices, for example, the user device(s) 115, the input device(s) 120, the user input device(s) 130, the user output device(s) 135, the output device(s) 140, one or more user interfaces, and/or one or more applications provided in the user device(s) 115. In some embodiments, the model(s) 225 is configured to learn and adapt itself to continuous improvement in changing environments. In some embodiments, the model(s) 225 employs any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, and/or soft computing. In some embodiments, the model(s) 225 implements an iterative learning process. The learning is based on a wide variety of learning rules or training algorithms. In an embodiment, the learning rules include one or more of back-propagation, federated learning, pattern-by-pattern learning, supervised learning, and/or interpolation. In some embodiments, the model(s) 225 includes multiple models, each configured to implement and/or execute one or more artificial intelligence algorithms to train at least one corresponding model. In accordance with some embodiments of the invention, the artificial intelligence algorithm utilizes any artificial intelligence methodology, now known or in the future developed, for classification. For example, the artificial intelligence methodology utilized includes one or a combination of: Linear Classifiers (Logistic Regression, Naive Bayes Classifier); Nearest Neighbor; Support Vector Machines; Decision Trees; Boosted Trees; Random Forest; and/or Neural Networks. In some embodiments, the model(s) 225 corresponds to one or more proprietary and/or open-source models forked, trained, weight customized, and/or tuned based on proprietary and/or open-source training data for performing functions consistent with the present disclosure. In embodiments, the weight customization involves modifying one or more parameters of a trained AI model to adapt a behavior of the trained AI model for one or more new tasks or contexts, by fine-tuning existing weights associated with the trained AI model and/or freezing specific artificial intelligence (AI) layers of the trained AI model. In embodiments, the fine-tuning of the existing weights corresponds to initializing new weights with custom values and distributions. The weight customization process allows for improved model control, model performance, and specialized capabilities by adjusting the learned knowledge stored within the trained AI model. The weights in AI models refer to numerical values that determine a strength and direction of connections between nodes in artificial neural networks.

In some embodiments, the model(s) 225 continually monitors and evaluates one or more user interaction events, via the input device(s) 120 and/or the user input device(s) 130, corresponding to a contextually aware user interface provided in the user device(s) 115, the user output device(s) 135, and/or the output device(s) 140. Examples of the one or more user interaction events include, but are not limited to, one or more text, voice, video, image, animation, gesture, Augmented Reality (AR), Virtual Reality (VR), Mixed Reality (MR), electro-mechanical inputs and any other human-computer interaction inputs received from the input device(s) 120 and/or the user input device(s) 130 corresponding to the contextually aware user interface and/or one or more user interface elements provided in the contextually aware user interface. The artificial intelligence intent is to generate or identify one or more contextual responses and/or contextual content based on the one or more user interaction events and manipulate the contextually aware user interface to provide one or more contextual responses and/or one or more contextual content associated with the one or more user interaction events via the contextually aware user interface. In accordance with various embodiments, the model(s) 225 is pretrained on a training input data set to generate or identify the one or more contextual responses and/or contextual content corresponding to the one or more user interaction events. In some embodiments, the server 110 is configured to obtain the training input data set from at least one information source, including, but not limited to, prestored data in at least one data repository included in the server memory 215, information provided by a user via one or more server input devices (not shown), one or more external/remote cloud, virtual, and/or physical servers, the Internet, and/or any other data source or repository that is in direct or indirect communication with the server 110. In some embodiments, the training input data set includes, but is not limited to, one or more search history/inputs, chat history/inputs, audio, video, and audio-visual content, internet websites, web content included in the websites, and multi-media data repositories included in the server memory 215 and/or hosted on cloud or distributed servers. Examples of the web content include, but is not limited to, visible content provided in the websites, one or more back-end assets, filed, documents, source code, application programming interfaces (APIs) associated with the visible content, and any other type of web content presently known or in future developed. Examples of the back-end files/documents include, but not limited to, Hypertext Markup Language (HTML), Extensible Markup Language (XML), Cascading Style Sheets (CSS) documents/files, and any other type of file that is presently known or in future developed and is not directly visible and/or accessible to a user. Examples of the one or more APIs include, but are not limited to, virtual or shadow Document Object Model (DOM) models, Browser Object Models (BOMs), Simple API for XML (SAX), XPath Data Models (XDM), JQuery, Angular, Vue frameworks, and any other type of API presently known or in future developed.

In some embodiments, the model(s) 225 continuously fine-tunes the one or more models and/or algorithms in the model(s) 225 based on the training input data set, additional data retrieved/scraped from the Internet or any other data source/repository, one or more outputs, herein referred to as “training output data set”, generated by the model(s) 225, and/or feedback received via the input device(s) 120 and/or the user input device(s) 130 corresponding to the training output data set. Examples of the training output data set include, but are not limited to, the generated contextual responses and/or content and/or the manipulated contextually aware user interface including the generated contextual responses and/or content corresponding to the training input data set. In some embodiments, the training output data set corresponding to the manipulated contextually aware user interface includes, but is not limited to, manipulated back-end files/documents by the model(s) 225 based one or more interface manipulation techniques including, but not limited to, Document Object Model (DOM) manipulation. The DOM manipulation corresponds to a process of using a scripting language, for example, JavaScript, to interact with and modify the Document Object Model (DOM) of a web page. The DOM represents the Hypertext Markup Language (HTML) or Extensible Markup Language (XML) document as a tree-like structure of objects, in which, each element, attribute, and text within the document is a node. In some embodiments, the model(s) 225 also adaptively modifies, enhances, and/or refines the training output data set, for example, the generated contextual responses or content, or the manipulation of the contextually aware user interface, until model(s) 225 ascertains that the artificial intelligence intent of the model(s) 225 is satisfactorily and/or optimally met using the one or more artificial intelligence algorithms in the model(s) 225 and/or continuous user feedback corresponding to the training output data set. Once the model(s) 225 is trained, the model(s) 225 responds to and determines, via the input device(s) 120 and/or the user input device(s) 130, the one or more user interaction events corresponding to the contextually aware user interface, continuously and adaptively generates contextual responses and/or content based on the one or more interaction events, manipulates of the contextually aware user interface, and provides the contextual responses and/or content to the user device(s) 115 via the manipulated contextually aware user interface in real-time.

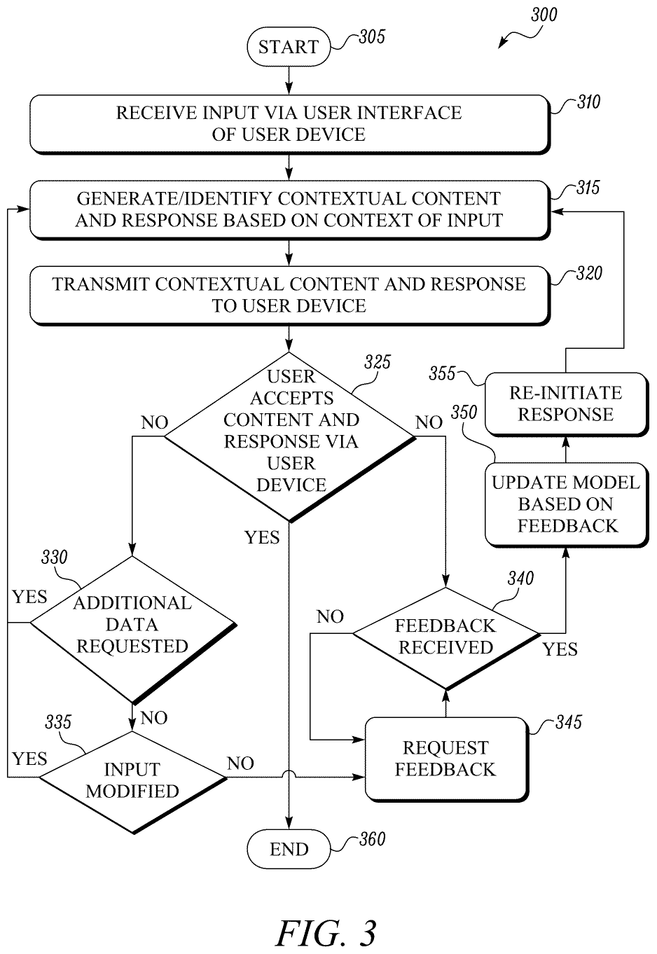

For example, referring to FIG. 3, an exemplary flowchart indicative of an exemplary process 300 for training, updating, modifying, and/or optimizing the model(s) 225 provided in the exemplary server of FIG. 2 is disclosed. The process 300 starts at 305 and proceeds to 310. At 310, the server 110 is configured to receive a user input from a user device, for example, 115-1 of the user device(s) 115 (see FIG. 1) and/or the input device(s) 120. At 315, the server 110 is configured to generate and/or identify, via the model(s) 225, a contextual content and/or a response corresponding to the received user input from the user device 115-1. At 320, the server 110 is configured to transmit the generated and/or identified contextual response to the user device 115-1. At 325, the server 110 is configured to determine whether a user operating the user device 115-1 has accepted the at least one provided contextual response and/or content or requested a modification to the at least one provided contextual response and/or content. At 325, when the server 110 determines that user has requested modification to the at least one provided contextual response and/or content, the server 110 is configured to perform 330 and 340. At 325, when the server 110 determines that user has accepted the at least one provided contextual response and/or content, the process 300 proceeds to 360 and ends. At 330, when the user requests modification of the received contextual response, the server 110 determines whether the additional data or information related to the at least one provided contextual response and/or content is requested by the user device 115-1. At 330, when the server 110 determines that the user device 115-1 has requested additional data or information related to the at least one provided contextual response and/or content, the server 110 is configured to repeat 315, 320, 325. At 330, when the server 110 determines that the user device 115-1 has not requested for the additional data or information related to the at least one provided contextual response and/or content, the server 110 is configured to perform 335. At 335, the server 110 determines whether the user device 115-1 has modified the previously received input and/or the previously determined context associated with the previously received input. At 335, when the server 110 determines that the previously received input and/or the previously determined context is modified, the server 110 is configured to repeat 315, 320, 325. At 335, when the server 110 determines that the previously received request has not been modified, the server 110 is configured to perform 345. At 345, the server 110 is configured to send a request, via the server transceiver 210 (see FIG. 2) and the network 125 (see FIG. 1), to the user device 115-1 to receive feedback associated with the at least one previously contextual response and/or content and perform 340. At 340, the server 110 is configured to determine whether feedback from the user operating the user device 115-1 has been received corresponding to the at least one previously provided contextual response and/or content from the user device 115-1. At 340, when the server 110 determines that the feedback is received, the server 110 is configured to perform 350. At 350, the server 110 is configured to update the model(s) 225 based on the feedback received and perform 355. At 355, the server 110 is configured to re-initiate the previously received input from the user device 115-1 and repeat 315, 320, and 325 based on the updated model(s) 225.

Referring again to FIG. 2, the server processor 205 is configured to execute the instructions and/or the model(s) 225 stored in the server memory 215 to perform the predetermined operations. The server processor 205 includes one or more microprocessors, microcontrollers, DSPs (digital signal processors), state machines, logic circuitry, or any other device or devices that process information or signals based on operational or programming instructions. The server processor 205 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The server processor 205 is configured to cooperate with other components of the server 110 to perform different operations described hereinafter.

In accordance with various embodiments, the server 110 is configured to provide, via the server transceiver 210 and the network 125, a contextually aware user interface on the at least one user device, for example, 115-1. In some embodiments, the server 110 is configured to provide the contextually aware user interface as a web application, a desktop or stand-alone application, a widget, an Augmented Reality (AR), Virtual Reality (VR), or Mixed Reality (MR) interface/module, or as part of an operating system provided in the at least one user device, for example, 115-1. In some embodiments, the contextually aware user interface corresponds to, but is not limited to, an artificial intelligence chat interface, an artificial intelligence voice assistant related interface, an online collaboration communication and platform, a content management system interface, a search engine interface, a media player interface, a screen-reading interface, or any other user interface presently known or developed in the future. It will be apparent to those with ordinary skill in the art that the contextually aware user interface provided by the server 110 corresponds to a user interface that is rendered contextually aware by the server 110 by determining and/or providing contextual bi-directional data communication between the at least user device, for example, 115-1 and the server 110 in real-time using, for example, the model(s) 225. For example, the server 110 is configured to continuously and dynamically modify the user interface provided on the user device(s) 115 in response one or more user inputs received and/or one or more user interaction events determined via the user device(s) 115 and/or the input device(s) 120 in order to render the user interface to be contextually aware. In some embodiments, the server 110 is also configured to provide, via the user output device(s) 135 of the at least one user device, for example, 115-1, at least one visually constrained interface element on the contextually aware user interface. Examples of the at least one visually constrained interface element include, but are not limited to, one or more links, images, text, video, audio, navigation links or icons, boxes, sliders, sidebar elements, header/footer elements, call-to-action buttons/links, and/or any other user interface element now known or in future developed. In embodiments, the visually constrained element(s) correspond to one or more interactive components provided within the user interface and a design and/or behavior of the interactive component(s) are subject to one or more specific limitations, rules, and/or constraints for specific purposes including, but not limited to, to guide user interaction, maintain consistency in visual display of the interactive component(s), ensure accessibility, and adapt to different screen sizes of the user device(s) 115.

In some embodiments, the server 110 is configured to determine, via the user input device(s) 130 and/or the input device(s) 120 and the network 125, at least one user interaction event corresponding to the contextually aware user interface. In some embodiments, the at least one user interaction event corresponds to at least one input received via the input device(s) 120 and/or the user input device(s) 130. Examples of the at least one input include, but are not limited to, a text, audio, a real-time video, gesture, AR/VR/MR, multi-media, and any other input including, but not limited to, one or more electro-mechanical signals/input received from electro-mechanical devices including, but not limited to, a joystick, a trackpad, and a computer mouse. For example, the server 110 is configured to receive, via the input device(s) 120 and/or the user input device(s) 130, at least one input, for example, a gesture, a selection, or a mouse click, corresponding to or associated with the at least one visually constrained interface element. In such embodiments, the gesture, the selection, or the mouse click corresponds to the at least one determined interaction event. As another example, the server 110 is configured to receive, via the input device(s) 120 and/or the user input device(s) 130, at least one text input and/or at least one audio input in a natural language format. In such embodiments, the receipt of the at least one text input and/or the at least one audio input corresponds to the at least one determined interaction event. In some embodiments, the server 110 is configured to commence, via the model(s) 225, an interactive session in response to the at least one received input, for example, the at least one text input and/or the at least one received audio input. In some embodiments, the server 110 is also configured to identify, via the model(s) 225, at least one historical user interaction event stored in the server memory 215 and/or one or more external data or memory sources/repositories, corresponding to and associated with the at least one determined user interaction event. In some embodiments, the at least one historical user interaction event is associated with one or more previously received user interaction events and/or inputs from multiple user devices, for example, the user device(s) 115 and/or the input device(s) 120. In some embodiments, the server 110 is also configured to assign, via the model(s) 225, a priority to the at least one determined user interaction event based on one or more factors including, but not limited to, processing resources to be allocated corresponding to the determined interaction event(s), a media type, a size, a length, and/or a duration of the determined interaction event(s), network bandwidth and/or speed of the network 125, user-defined or requested priority corresponding to the determined interaction event(s) received from the input device(s) 120 and/or the user input device(s) 130, and any other factor associated with managing the at least one determined user interaction event. As an example, the server 110 is configured to assign a higher priority to the determined interaction event corresponding to a video, image, animation, gesture, Augmented Reality (AR), Virtual Reality (VR), and/or Mixed Reality (MR) input in comparison to the determined interaction event corresponding to text and/or voice inputs. It should be understood that the example provided herein is only one of the examples for assigning the priority to the determined interaction event(s) and additional parameters and/or factors for assigning the priority to the determined interaction event(s) by the server 110 are also contemplated. For example, in some embodiments, the server 110 is also configured to assign, via the model(s) 225, the priority to the at least one determined user interaction event based on a previously assigned priority to the at least one identified historical user interaction event corresponding to the at least one determined user interaction event and/or at least one historical content associated with the at least one identified historical user interaction event. For example, the server 110 is also configured to assign, via the model(s) 225, the priority to the at least one determined user interaction event based on one or more parameters including, but not limited to, a rating, a quality, a length and/or duration, and/or a relevance associated with the at least one historical content determined based on user inputs received corresponding the at least one identified historical user interaction event from the input device(s) 120 and/or the user input device(s) 130, and/or by the model(s) 225.

In some embodiments, the server 110 is configured to determine, via the model(s) 225, a context associated with the at least one determined user interaction event. The context corresponds to data or information that is used by the model(s) 225 to define a scope and one or more parameters of a calculation or process such that the model(s) 225 interprets the at least one determined user interaction event based on the defined scope and the defined parameters of the calculation or the process. In some embodiments, the scope includes, but is not limited to, a type, a function, and/or use of the contextually aware user interface provided, a user profile and/or one or more user preferences of a user interacting with the contextually aware user interface, a type and speed of network connection between the user device(s) 115 and the server 110, one or more visual elements provided on the contextually aware user interface, one or more back-end scripting platforms, languages, files, and/or documents associated with the one or more visual elements and/or the contextually aware user interface, a current location of the user device(s) 115, one or more regulatory policies associated with the current location, and/or any other factor that governs, influences, and/or is associated with the at least one determined user interaction event. In some embodiments, the parameters include, but are not limited to, gestures, keywords, identifiers, stored data associated with the at least one determined user interaction event in the server memory 215, a communication pattern, tone and/or pitch, and/or any other attribute, feature, or characteristic associated with the at least one determined user interaction event received via the input device(s) 120 and/or user input device(s) 130. As an example, the server 110 is configured to determine, via the model(s) 225, the context associated with the at least one visually constrained interface element based on the at least one received input corresponding to the at least one visually constrained interface element. Similarly, in another example, the server 110 is configured to determine, via the model(s) 225, the context associated with the at least one received text input and/or the at least one received audio input.

In some embodiments, the server is configured to determine the context by identifying, via the server processor 205, at least one keyword, action, and/or gesture in the at least one received input. In some embodiments, the server 110 is also configured to retain, via the model(s) 225, the determined context associated with the at least one determined user interaction event, for example, the at least one text input and/or the at least one audio input, upon receipt of at least one subsequent text input, audio input, or a combination thereof during the commenced interactive session. In some embodiments, the server 110 is also configured to determine the context based on a combination of a plurality of received inputs. For example, server 110 is configured to receive an image input and a text input corresponding to the image input from the user device(s) 115. The server 110 is then configured to determine the context based on the combination of the image input and the text input. In some embodiments, the server 110 is configured to implement, via the model(s) 225, one or more Natural Language Processing (NLP) algorithms, Audio, image and/or video analysis and/or processing algorithms to process the determined user interaction event(s) and/or inputs and determine the context based on the processing. As an example, the server 110 is configured to receive, via the user device, for example 115-1, a first image input of a motor vehicle, and a second text input as “Give me all the details about this motor vehicle”. The server 110 is then configured to apply, via the model(s) 225, one or more image analysis algorithms to process and analyze the first image input and process. Similarly, the server 110 is configured to apply, via the model(s) 225, the one or more NLP algorithms to analyze the second text input. The server 110 is then configured to determine the context associated with the combination of the first image input and the second text input based on the processing and analysis performed by the model(s) corresponding to the first image input and the second text input. For example, the server 110 is configured to determine the context corresponding to providing details associated with the motor vehicle visible in the first image input based on the processing and analysis of the first image input and the second text input by the model(s) 225. In some embodiments, the server 110 is configured to retain the determined context for a first predefined time interval during the interactive session and/or after a second predefined time interval of non-receipt of the at least one user interaction event. In some embodiments, the server 110 is configured to commence a subsequent interactive session upon receipt of the at least one user interaction event determined after the second predefined time interval. In some embodiments, the server 110 is also configured to retain the determined context across multiple interactive sessions between the user device(s) 115 and the server 110.

In some embodiments, the server 110 is configured to perform at least one action based on the determined context. For example, the server 110 is configured to perform the at least one action of initiating one or more computer programs/applications and/or performing one or more corresponding program/application functions, and/or generating one or more contextual responses and/or content in response to and/or based on the determined context. In some embodiments, the server 110 is configured to initiate the computer programs/applications stored in the server memory 215 and/or one or more external data and/or memory sources/repositories including, but not limited to, data stored in one or more remote servers (not shown), or any other non-volatile media including, but not limited to, one or more hard-drives and Universal Serial Bus (USB) drives. In some embodiments, the server 110 is also configured to send, via the model(s) 225, an Application Programming Interface (API) request to at least one additional server (not shown) to initiate the one or more computer programs/applications and/or perform the one or more program/application functions. In such embodiments, the server 110 is configured to identify, via the model(s) 225, at least one contextual computer program/application and/or the corresponding program/application function to be performed and/or executed and execute, via the model(s) 225, the at least one identified contextual computer program/application and/or perform the corresponding one or more program/application functions. Examples of the one or more computer programs/applications and/or functions include, but are not limited to, one or more programs/application or functions associated with screen recording and/or sharing, annotation, animation, content analysis, image/video generation, messaging applications, Enterprise Resource Planning (ERP) applications, customer relationship management (CRM) applications, and any other computer program, application, or function presently known or in future developed. In some embodiments, the server 110 is also configured to provide one or more outputs of the one or more computer programs/applications, and/or the functions to the user device(s) 115 via the contextually aware user interface. As an example, the server 110 is configured to initiate a screen recording program or function based on the determined context corresponding to a voice input indicating ‘Let's do a walk-around of the motor vehicle’ received from the user device, for example, 115-1 and indicate the initiation of the screen recording program via the contextually aware user interface.

In some embodiments, the server 110 is also configured to generate and/or identify, via the model(s) 225, at least one contextual content associated with the at least one determined user interaction event based on the determined context. In some embodiments, the server 110 is configured to generate generative contextual content and/or identify prestored contextual content in the server memory 215 or the one or more external data or memory sources/repositories based on the determined context. Examples of the at least one contextual content include, but are not limited to, text, image, video, animation, audio, audio-visual, AR/VR/MR, and any other multi-media content presently known or in future developed. In some embodiments, to generate and/or identify the context content, the server 110 is configured to map, via the server processor 205, the at least one identified keyword or a portion of the at least one identified keyword, the identified action, and/or the identified gesture in the at least one determined user interaction event, for example, the at least one received input, with at least one media tag associated with at least one database content stored in the server memory 215 and/or the one or more external data or memory sources/repositories. In such embodiments, the server 110 is configured to generate and/or identify, via the server processor 205 and the model(s) 225, the at least one contextual content associated with the at least one receive input based on the mapping. For example, the server 110 is configured to store one or more database contents including, but not limited to, text, image, video, animation, Augmented Reality (AR), Virtual Reality (VR), Mixed Reality (MR), and any other type of content associated with one or more reference materials including, but not limited to, subjects, objects, topics, and keywords in the server memory 215. The server 110 is also configured to assign and store, via the model(s) 225, one or more media tags corresponding to each database content stored in server memory 215. As an example, the server 110 is configured to store text, image, video, and/or animation associated with one or more motor vehicles and include media tags such as “hatchback”, “SUV”, “coupe”, “sedan”, and “convertible”. Upon determination of the user interaction event(s)/input(s) and/or the context associated with the determined user interaction event(s)/input(s), the server 110 is configured to identify one or more keywords, and/or a combination of words in the user interaction event(s) and/or user input(s) and map the identified keyword(s) and/or the combination of words with the one or more media tags stored in the server memory 215. The server 110 is also configured to identify the database content(s) associated with the media tag(s) that map and/or are correlated with the identified keyword(s) and/or the combination of words. In embodiments, the server 110 is also configured to retrieve the identified database content(s) as the contextual content(s) corresponding to the received user input(s) or the determined user interaction event(s) and/or also generate generative artificial intelligence content based on the identified database content(s). As an example, the server 110 is configured to identify the keywords “small”, “car”, “boot space” in the received input(s), via the contextual aware user interface, determine the context of the received input(s), map the keywords with the stored media tag(s), identify the media tag “hatchback” that maps onto and/or is correlated to the identified keywords based on determined context, identify the text, image, video, and/or animation content associated with the identified media tag “hatchback” as the identified contextual content(s), and/or generate generative AI content based in the identified text, image, video, and/or animation content associated with the identified media tag “hatchback”. In some embodiments, the server 110 is configured to generate the generative AI response and/or content by using one or more neural networks of the model(s) 225 that identify one or more patterns in the identified text, image, video, and/or animation content associated with the identified media tag(s). In such embodiments, the neural networks of the model(s) 225 also predict statistically probable pieces of content, for example, a word or image pixel, in a sequence based on the identified pattern(s), and generate the generative AI response and/or content including a combination of the sequential pieces of content based on the prediction.

In some embodiments, the server 110 is also configured to determine, via the server processor 205 and the model(s) 225, a semantic correlation between the at least one generated and/or identified contextual content and the at least one received input. In some embodiments, the server 110 is configured to map one or more keyword(s) of the received input(s) from the user input device(s) 130 and/or the input device(s) 120 with the generated and/or identified contextual content(s) to determine the semantic correlation. In some embodiments, the server 110 is configured to analyze existing knowledge structures including, but not limited to, to ontologies and thesauruses stored in the server memory 215 and/or one or more external data repositories to define one or more relationships between the received input(s) and the generated and/or identified contextual content(s) and establish the semantic correlation. In some embodiments, the server 110 is also configured to generate mathematical representations via one or more techniques including, but not limited to, vectorization, of the received input(s) and the generated and/or identified contextual content(s) and determine the semantic correlation between the generated mathematical representations. In such embodiments, the server 110 is configured to determine, via the server processor 205 and the model(s) 225, a relevance score based on the determined sematic correlation. In such embodiments, the server 110 is configured to generate and/or identify, via the server processor 205 and the model(s) 225, the at least one contextual content based on the determined relevance score. In some embodiments, the server 110 is also configured to assign, via the model(s) 225, a priority to a media type of the at least one generated and/or identified contextual content based on one or more factors including, but not limited to, historical user interaction event(s) associated with the at least one determined user interaction event, network connection, speed, and/or bandwidth between the user device(s) 115 and the server 110, and a relevance of the media type corresponding to the determined context determined by the server 110. As an example, the server 110 is also configured to assign, via the model(s) 225, a higher priority to a generated and/or identified contextual video content in comparison to a generated and/or identified contextual text content based on the relevance of the generated and/or identified contextual video and text content corresponding to the determined context. As another example, the server 110 is also configured to assign, via the model(s) 225, a higher priority to a generated and/or identified contextual text content in comparison to a generated and/or identified contextual video content corresponding to the determined context based on the network speed and/or bandwidth of the network 125 during the communication between the user device(s) 115 and the server 110.

In some embodiments, the server 110 is also configured to generate and/or identify, via the model(s) 225, at least one contextual response corresponding to the at least one determined user interaction event based on the determined context. In some embodiments, the server 110 is also configured to generate and/or identify, via the model(s) 225, the at least one contextual response in addition to the at least one generated and/or identified contextual content. In some embodiments, a media type of the at least one generated contextual response and the at least one identified contextual content is same or different from each other. Examples of the at least one contextual response include, but are not limited to, at least one text, image, audio, video, animation, AR/VR/MR, or any other type of multi-media response presently known or in future developed. In some embodiments, the server 110 is also configured to identify, via the model(s) 225, the at least one contextual response based on prestored data stored in the server memory 215 and the determined context. In some embodiments, the server 110 is also configured to implement Retrieval Augmented Generation (RAG) technique to generate the at least one contextual content and/or response. The Retrieval-Augmented Generation (RAG) technique is an AI technique that enhances performance of the model(s) 225 by allowing the model(s) 225 to access and incorporate up-to-date, specific information from pre-stored data in the server memory 215 to generate accurate and relevant contextual content and/or response. In embodiments, the model(s) implements the RAG technique by retrieving pre-stored data including, but not limited to, one or more relevant documents, data snippets, and/or media content in response to the at least one receive input from the user device(s) 115 and generates a system prompt using the retrieved data which is then provided to the model(s) 225 again to generate the at least one contextual content and/or response. The RAG technique ensures that the model(s) 225 is provided with current, proprietary, and/or specialized data, and thereby enabling the model(s) 225 to provide reliable, context-aware, and trustworthy output(s) based on the provided data without having to retrain the model(s) 225 and/or thereby, minimizing time, effort, and/or resources to retrain the model(s) 225 based on the provided data.

In some embodiments, the server 110 is configured to store, via the server processor 205, at least one master system prompt in the server memory 215 and/or one or more external data or memory sources/repositories. In some embodiments, the at least one master system prompt defines an expected behavior and/or an expected personality to be indicated via the at least one generated content and/or response by the model(s) 225. In such embodiments, the server 110 is configured to store, via the processor, at least one content or content module in the server memory 215 and/or one or more external data or memory sources/repositories and each of the at least one stored content or content module is associated with at least one corresponding content identifier. In such embodiments, the server 110 is also configured to embed, via the server processor 205, the at least one content identifier in the at least one master system prompt. In such embodiments, upon the determination of the at least one user interaction event and based on the determined context, the server 110 is also configured to fetch, via the server processor 205, the at least one stored master system prompt, parse, via the server processor 205, the at least one stored master system prompt, and identify, via the server processor 205, the at least one content identifier embedded in the at least one stored master system prompt. In such embodiments, the server 110 is also configured to retrieve, via the server processor 205, the at least one content or content module associated with the at least one identified content identifier. In such embodiments, the server 110 is also configured to replace, via the server processor 205, the at least one content identifier embedded in the at least one stored master system prompt with the at least one retrieved content or content module. In such embodiments, the server 110 is also configured to generate, via the server processor 205, a run-time system prompt comprising the at least one master system prompt and the at least one retrieved content or content module included in the at least one master system prompt. In such embodiments, the server 110 is also configured to provide, via the server processor 205, the at least one run-time system prompt to the model(s) 225 and generate, via the model(s) 225, the at least one response based on the at least one provided run-time system prompt. In some embodiments, the at least one generated response is indicative of the expected behavior and/or an expected personality defined in the at least one master system prompt.

As an example, the server 110 is configured to store a master prompt indicating ‘You are a #friendly101 chatbot helping users with information they seek. Provide a high-level output to user queries. Identify #text101 and #image101 and supplement it with #video101 if available’ in which the ‘#text101’, ‘#image101’, and ‘#video101’ correspond to content identifiers. Upon the determination of the user interaction event(s) and/or receipt of one or more input(s) from the user input device(s) 130 and/or the input device(s) 120, the context associated with the user interaction event(s) and/or input(s), and the generated contextual response and/or content(s), the server 110 is configured to identify the media tags, for example, ‘#hatchbackspecs’, ‘#hatchbackbrochure’, and ‘#hatchbackadvertisement’, associated with the generated contextual response and/or content(s) and the corresponding content identifiers, for example, ‘hbs1’, ‘hbb1’, and ‘hbad1’. The server 110 is then configured to replace the default content identifiers, for example, ‘#text101’, ‘#image101’, and ‘#videot101’ in the master prompt with the identified content identifiers, for example, ‘hbs1’, ‘hbb1’, and ‘hbad1’, and provide the run-time system prompt indicating ‘You are a friendly chatbot helping users with information they seek. Provide a high-level output to user queries. Identify #hbs1 and #hbb1 and supplement it with #hbad1 if available’ to the model(s) 225. The server 110 is then configured to modify the generated and/or identified response and/or content based on the run-time prompt such that the modified response and/or content(s) is indicative of the expected behavior and/or personality defined by the run-time system prompt and/or modified master prompt.

In some embodiments, the server 110 is also configured to modify the at least one master system prompt in real-time based on one or more inputs received from the user input device(s) 130, and/or the input device(s) 120. In such embodiments, the modification of the at least one master system prompt corresponds to a modification in the expected behavior and/or the expected personality to be indicated via the at least one generated response by the model(s) 225. In such embodiments, the server 110 is configured to receive, via the user input device(s) 130, and/or the input device(s) 120, at least one alternative content or content module. In such embodiments, the server 110 is also configured to store, via the server processor 205, the at least one received alternative content or content module in the server memory 215 and/or one or more external data or memory sources/repositories. In such embodiments, the server 110 is also configured to assign, via the server processor 205, the at least one content identifier corresponding to the at least one received alternative content or content module. In such embodiments, the server 110 is also configured to replace, via the server processor 205, the at least one embedded content identifier in at least one master system prompt with the at least one assigned content identifier to modify the at least one master system prompt. In some embodiments, the at least one modified master system prompt based on the replacement is indicative of a user expected behavior and/or a user expected personality to be indicated via the at least one generated response by the model(s) 225.

For example, the server 110 is configured to the server 110 is configured to store a master prompt indicating ‘You are a #friendly101 chatbot helping users with information they seek’. Upon receipt of a text input from the user device, for example, 115-1 indicating ‘Be wise, straightforward, and honest in your response’, the server 110 is configured identify the terms ‘wise’, ‘straightforward’, and ‘honest’ as the alternative content indicative of a user-expected behavior and personality in the generated and/or identified contextual response and/or content(s). The server 110 is also configured to assign content identifiers, for example, ‘#knowledge’, ‘#to-the-point’, and ‘#logical’ corresponding to the identified alternative content and/or content module and replace the default content identifiers, for example, ‘#friendly101’, in the master prompt with the identified content identifiers, for example, ‘#knowledgeable’, ‘#to-the-point’, and ‘#logical’, and provide the run-time system prompt indicating ‘You are a #knowledgeable #to-the-point’ #logical chatbot helping users with information they seek.’ to the model(s) 225. The server 110 is then configured to modify the generated and/or identified response and/or content based on the run-time prompt such that the modified response and/or content(s) is indicative of the user expected behavior and/or personality.

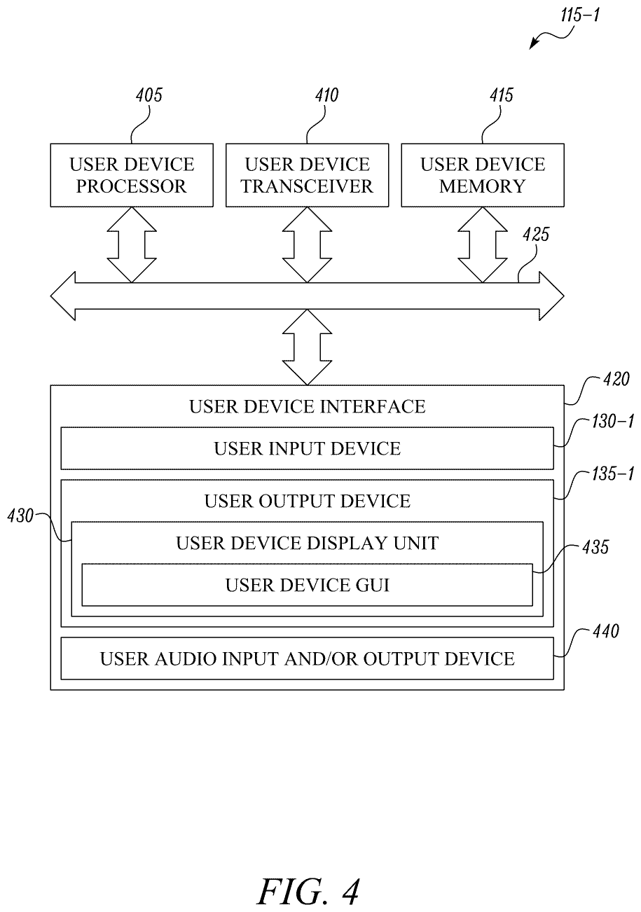

In some embodiments, the server 110 is also configured to manipulate, via the model(s) 225, the contextually aware user interface provided on the user device(s) 115 in order to provide the at least one generated response and the at least one generated and/or identified contextual content to the user device(s) 115. In some embodiments, the server 110 is configured to determine, via the user device(s) 115 and the network 125, information associated with the user device(s) 115 and/or the contextually aware interface provided on the user device(s) 115. Examples of the information include, but are not limited to, a screen size and/or resolution of a user device display unit, for example, 430 (see FIG. 4) of each user device, for example, 115-1 and/or the contextually aware user interface. In some embodiments, the server 110 is configured to determine, via the server processor 205, one or more visual portions within the contextually aware user interface for providing the generated and/or identified contextual content(s) and response(s) within the contextually aware user interface based on the determine information. In some embodiments, the server 110 is also configured to determine a shape and/or a size of each determined visual portion within the contextually aware user interface. In some embodiments, the server 110 is also configured to determine the shape and/or the size of each determined visual portion based on a size and/or an amount of response data and/or content data included in the generated and/or identified content(s) and response(s). In some embodiments, the server 110 is configured to manipulate the contextually aware user interface based on the determined information and the determined shape and size of each determined visual portion. In some embodiments, the server 110 is also configured to determine a type of manipulation to be performed corresponding to the contextually aware user interface based on the received user inputs and/or the determined context. Examples of the type of manipulation include, but are not limited to, overlaying the generated and/or identified contextual content(s) and response(s) over existing content provided on the contextually aware user interface, aligning the generated and/or identified contextual content(s) and response(s) around and/or adjacent to existing content provided on the contextually aware user interface, and any other type of manipulation of the contextually aware user interface that is presently known or in future developed.

In some embodiments, the manipulation of the contextually aware user interface corresponds to manipulation of backend documents/files associated with the contextually aware user interface based on the determined type of manipulation. For example, the manipulation of the contextually aware user interface corresponds to the Document Object Model (DOM) manipulation to dynamically change a content, structure, or style of the contextually aware user interface. In some embodiments, to perform the DOM manipulation, the server 110 is configured to interact with the Document Object Model (DOM) associated with the contextually aware user interface. For example, the server 110 is configured to interact with the HTML document represented as a tree-like structure of one or more nodes, each representing a user interface element provided or to be provided on the contextually aware user interface. In such embodiments, the server 110 is configured to selectively add, remove, and/or update the one or more user interface elements. In such embodiments, the server 110 is also configured to selectively change one or more attributes associated with the one or more user interface elements and modify the style or structure of the one or more user interface elements. As an example, the server 110 is configured to manipulate, via the model(s) 225, the contextually aware user interface to provide at least one expanded view associated with the at least one visually constrained interface element in response to the at least one determined user interaction event and based on the determined context. In some embodiments, the at least one expanded view includes the at least one generated response and the at least one generated or identified contextual content. In some embodiments, the server 110 is also configured to manipulate, via the at least one artificial intelligence model, the contextually aware user interface such that the contextually aware user interface transitions from the at least one provided contextual content to at least one additional contextual content upon determination of at least one subsequent user interaction event via the user input device(s) 130 and/or the input device(s) 120. In some embodiments, server 110 is also configured to manipulate the contextually aware user interface such that one or more portions of the contextually aware user interface including the modified interface elements are dynamically changed/modified without regenerating or updating the contextually aware user interface in entirety with the modified interface elements. In some embodiments, the server 110 is also configured to generate one or more instructions to be provided, via the server transceiver 210 and the network 125 (see FIG. 1), to the user device(s) 115 to perform the manipulation. In such embodiments, the user device(s) 115 is configured to perform the manipulation of the contextually aware user interface based on the one or more instructions received from the server 110 via the network 125.

In some embodiments, the server 110 is configured to provide, via the user output device(s) 135, the output device(s) 140 and/or the manipulated contextually aware user interface of user devices(s) 115, the at least one generated contextual response and/or the at least one generated and/or identified contextual content in response to the at least one received input. In some embodiments, the server 110 is configured to provide a combination of the at least one generated and/or identified contextual response and content of different media types respectively. For example, the server 110 is configured to provide the at least one generated contextual response as one or more text responses and the at least one contextual content as one or more audio, image, video, and/or animation contents. In some embodiments, the server 110 is configured to provide the at least one identified contextual content based on the assigned priority corresponding to the at least one identified contextual content. In some embodiments, the server 110 is configured to provide the combination of the at least one generated and/or identified contextual response and content at different visual portions of the manipulated contextually aware user interface respectively. In some embodiments, the server 110 is configured to provide the combination of the at least one generated and/or identified contextual response and/or content at the different visual portions having same or different sizes or dimensions respectively. In some embodiments, for example, when the at least one identified contextual content includes audio/video content, the server 110 is configured to provide, via the model(s) 225 and the user device(s) 115, the audio/video content as an audio/video stream and at least one partial transcript corresponding to a portion of the provided audio/video stream in real-time and/or a complete transcript of the provided audio/video stream after the providing of the audio/video stream in entirety.

In some embodiments, the server 110 is configured to synchronize, via the model(s) 225, the providing of the at least one generated and/or identified contextual content and/or response on the user device(s) 115 and/or the output device(s) 140 such that at least one response data included in the at least one provided response correlates with the at least one provided contextual content. For example, the server 110 is configured to provide the contextual content corresponding to a video stream and the contextual response corresponding to transcript associated with the video stream simultaneously. In some embodiments, the server 110 is also configured to determine a correlation between content data associated with the at least one generated and/or identified contextual content and response data associated with the at least one generated and/or identified contextual response. The response data corresponds to data including, but not limited to, text included in and/or associated with the contextual response. The content data corresponds to data including, but not limited to, one or more file names, tags, identifiers, metadata, and/or artificial intelligence/machine learning based analysis and/or processing output associated with the contextual content, for example, image/video. In such embodiments, the server 110 is configured to synchronize the providing of the at least one generated and/or identified contextual content and/or response on the user device(s) 115 and/or the output device(s) 140 based on the determined correlation. For example, the server 110 is configured to synchronize and provide the contextual response corresponding to one or more text responses and the contextual content corresponding to one or more images simultaneously and/or sequentially based on the determined correlation between the response data associated with the provided text response(s) and the content data associated with the one or more images.

In some embodiments, the server 110 is also configured to provide, via the user output device(s) 135, the output device(s) 140, and/or the manipulated contextually aware user interface of user devices(s) 115, at least one expanded view corresponding to the at least one visually constrained interface element in response to the at least one input received corresponding to the at least one visually constrained interface element. In some embodiments, the server 110 is also configured to provide at least one expanded view corresponding to the at least one visually constrained interface element as an overlay over the manipulated contextually aware user interface. In some embodiments, the server 110 is also configured to provide the at least one generated and/or identified contextual response and/or content in the at least one expanded view. In such embodiments, the server 110 is also configured to provide the at least one generated and/or identified contextual response and/or content at different visual portions of the at least one expanded view respectively. In such embodiments, the server 110 is also configured to provide the combination of the at least one generated and/or identified contextual response and content at the different visual portions having same or different sizes or dimensions respectively on the at least one expanded view.

In some embodiments, the server 110 is also configured to define a time duration for providing the at least one generated and/or identified contextual response and/or content. For example, the server 110 is configured to provide the at least one generated and/or identified contextual response and/or content for the defined time duration and remove the at least one generated and/or identified contextual response and/or content from the manipulated contextually aware user interface and/or the output device(s) 140 after the defined time duration. In some embodiments, the server 110 is also configured to provide, via the user output device(s) 135, the output device(s) 140 and/or the manipulated contextually aware user interface of user devices(s) 115, at least one subsequent generated and/or identified contextual response and/or content for another time duration after the removal of previously provided contextual response and/or content. In some embodiments, the at least one generated and/or identified contextual response and/or content corresponds to a plurality of generated and/or identified contextual responses and/or contents. In such embodiments, the server 110 is configured to provide, via the model(s) 225, the user device(s) 115, and/or the output device(s) 140, the plurality of generated and/or identified contextual responses and/or contents arbitrarily, sequentially, or simultaneously. In some embodiments, when the combination of the at least one generated and/or identified contextual response and the at least one generated and/or identified contextual content are provided, the server 110 is configured to provide the at least one generated and/or identified contextual content arbitrarily, sequentially, or simultaneously based on the at least one response data included in and/or the media type of the at least one generated and/or identified contextual response. In such embodiments, the server is also configured to provide the at least one generated and/or identified contextual response arbitrarily, sequentially, or simultaneously based on content data and/or a media type of the at least one generated and/or identified contextual content.

In some embodiments, the server 110 is configured to determine, via the server processor 205, a network jitter associated with the user device(s) 115 and/or the output device(s) 140 based on and/or in response to the at least one received input. The network jitter corresponds to a variation in time taken for network data packets to travel across the network 125. In such embodiments, the server 110 is configured to dynamically adjust, via the server processor 205, a network threshold and/or a buffer size associated with the at least one network buffer of the server memory 215 based on the determined network jitter. The network threshold is a pre-set condition or value by the server processor 205 that is used to trigger an alert when a network metric including, but not limited to, a network bandwidth utilization or error rate, exceeds or falls below a specified level by the server processor 205. The buffer size corresponds to an amount of temporary storage of the network data packets in the at least one network buffer. In some embodiments, the buffer size is a function of the determined network jitter. For example, the server 110 is configured to increase the buffer size based on a determination of an increase in the determined network jitter and reduce the buffer size based on a determination of a decrease in the determined network jitter over a predefined time period by the server processor 205. In such embodiments, the server 110 is also configured to queue, via the server processor 205, at least one data chunk associated with the at least one generated and/or identified contextual response and/or content based on the determined network jitter. In such embodiments, the server 110 is also configured to adjust at least one parameter associated with the at least one data chunk based on the determined network jitter, at least one historical network jitter pattern stored in the server memory 215 and/or the external data/memory sources or repositories. Examples of the at least one parameter include, but are not limited to, a delivery time interval, a sequence, and a packet length or size of the at least one data chunk. In such embodiments, the server 110 is also configured to provide, via the server processor 205, the at least one queued data chunk to the user device(s) 115 based on the dynamically adjusted network threshold.

The various components of one of the user device(s) 115, for example, the user device 115-1 will now be described hereinafter with respect to FIG. 4. It would be understood by those of ordinary skill in the art that the remaining user devices, for example, 115-2 through 115-n are also configured to include similar components with similar corresponding functional capabilities as compared to the various components of the user device 115-1 and the corresponding functions performed by the various components of the user device 115-1 as described hereinafter. It should be appreciated by those of ordinary skill in the art that FIG. 4 depicts the user device 115-1 in a simplified manner and a practical embodiment includes additional components and suitably configured logic to support known or conventional operating features that are not described in detail herein. Although the user device 115-1 is illustrated and described to be implemented within a single communication device, it is contemplated that the one or more components of the user device 115-1 are alternatively implemented in a distributed computing environment.

Referring to FIG. 4, the user device 115-1 includes, among other components, a user device processor 405, a user device transceiver 410, a user device memory 415, and a user device interface 420. The components of the user device 115-1, including the user device processor 405, the user device transceiver 410, the user device memory 415, and the user device interface 420, cooperate with one another to enable operations of the user device 115-1. The components of the user device 115-1 (for example 405, 410, 415, 420) are communicatively coupled via a user device local interface 425. The user device local interface 425 includes, for example, but is not limited to, one or more buses or other wired or wireless connections, as is now known in the art or in the future developed. In an embodiment, the user device local interface 425 has additional elements, which are omitted for simplicity, such as controllers, buffers (caches), drivers, repeaters, and receivers, among many others, to enable communications. Further, in some embodiments, the user device local interface 425 includes address, control, and/or data connections to enable appropriate communications among the aforementioned components.

As illustrated, the user device 115-1 includes the user device transceiver 410 to transmit one or more inputs to and receive one or more outputs from one or more other devices, (as illustrated in FIG. 1) such as, the server 110, the input device(s) 120, and/or the output device(s) 140. The user device transceiver 410 includes a transmitter circuitry and a receiver circuitry to enable the user device 115-1 to communicate with the one or more other devices. In this regard, the transmitter circuitry includes appropriate circuitry to transmit the one or more inputs to the one or more other devices, and the receiver circuitry includes appropriate circuitry to receive the one or more outputs from the one or more other devices. It will be appreciated by those of ordinary skill in the art that the user device 115-1 includes a single user device transceiver as illustrated, or alternatively separate transmitting and receiving components, for example but not limited to, a transmitter, a transmitting antenna, a receiver, and a receiving antenna.

In accordance with various embodiments, the user device interface 420 includes the user input device 130-1 (also see FIG. 1) to receive one or more inputs from a user and/or one or more sensor(s) (not shown) provided in the user input device 130-1. In some embodiments, the user input device 130-1 includes at least one audio-capturing device and at least one image-capturing device. In accordance with various embodiments, the user device interface 420 also includes a user output device 135-1 to provide outputs to the user. The user device interface 420 is configured to receive the inputs from and/or provide the outputs to the user via the user input device 130-1 and the user output device 135-1. Non-limiting examples of the user input device 130-1 include a touch screen display, an image capturing device (such as, a camera), a touch pad, a keyboard, a microphone, a recorder, a mouse, Augmented Reality (AR), Virtual Reality (VR), and/or Mixed Reality (MR) input, or any other user input mechanism integrated within or coupled to the user device 115-1, now known or developed in the future. Non-limiting examples of the user output device 135-1 include a user device display unit, for example, 430, a user audio input and/or output device 440 including, but not limited to, a microphone and/or speaker, a haptic output, or any other output mechanism integrated within or coupled to the user device 115-1, now known or developed in the future. The user device interface 420 further includes a serial port, a parallel port, an infrared (IR) interface, a universal serial bus (USB) interface and/or any other interface herein known or developed in the future.

In accordance with some embodiments, the user device display unit, for example, 430 includes a user device graphical user interface (GUI) 435 through which the user communicates with the server 110. The user device GUI 435 is an application or a web portal or any other suitable interface for accessing the server 110, the user input device 130-1, the input device(s) 120-1, and/or the output device(s) 140. The user device GUI 435 includes one or more graphical elements including, but not limited to one or more dialogue boxes, window, web forms, text input field, microphone button, camera button, file upload button, text output display window, audio player, image/video display window, and/or the like.

The user device display unit, for example, 430 is configured to display text, images, videos, numbers, infographics, charts, diagrams, motion graphics, typography, dialogue boxes, window, web forms, text input field, microphone button, camera button, file upload button, text output display window, audio player, image/video display window, and other graphical elements now known or developed in future. The user device display unit, for example, 430, includes a display screen, a head-mounted display, or a computer monitor now known or in the future developed. In accordance with some embodiments, the user device display unit, for example, 430 is configured to display on the user device GUI 435 the outputs received from the one or more other devices including, but not limited to, the server 110, the input device(s) 120, and/or the output device(s) 140.

In accordance with some embodiments, the user audio input and/or output device 440 is configured to receive one or more audio inputs including, but not limited to, one or more voice inputs and environmental sound inputs, and provide one or more audio outputs including, but not limited to, one or more voice outputs, sounds, alerts, and alarms. In some embodiments, the user audio input and/or output device 440 also includes an audio input and/or output port configured to accommodate a corresponding audio input and/or output plug associated with the another audio input and/or output device including, but not limited to, a wired earphone, headphone, on-ear headphone, and a speaker with a microphone that is now known or in future developed, to receive and provide the one or more audio inputs and the one or more audio outputs respectively. In some embodiments, the user audio input and/or output device 440 also includes an external device, for example, a Bluetooth® microphone and speaker device in wireless communication with the user device interface 420 via the network 125 (see FIG. 1).

The user device memory 415 is a non-transitory memory configured to store a set of instructions that are executable by the user device processor 405 to perform predetermined operations. For example, the user device memory 415 includes any of the volatile memory elements (for example, random access memory (RAM)), non-volatile memory elements (for example, read only memory (ROM)), and combinations thereof. Moreover, the user device memory 415 incorporates electronic, magnetic, optical, and/or other types of storage media. In accordance with some embodiments, the user device memory 415 is also configured to store the application associated with the user device GUI 435. In some embodiments, the user device memory 415 is also configured to store one or more inputs from the server 110, the user input device(s) 130-1, and/or the input device(s) 120. For example, the user device memory 415 is configured to store one or more user inputs received from the user input device 130-1 and/or the input device(s) 120 and/or one or more instructions, contextual contents, and/or responses received from the server 110.

The user device processor 405 is configured to execute the instructions stored in the user device memory 415 to perform the predetermined operations. The user device processor 405 includes one or more microprocessors, microcontrollers, DSPs (digital signal processors), state machines, logic circuitry, or any other device or devices that process information or signals based on operational or programming instructions. The user device processor 405 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The user device processor 405 is configured to cooperate with other components of the user device 115-1 to perform operations described hereinafter.

The user device 115-1 is configured to receive the at least one real-time user input via the user input device 130-1 and/or the input device(s) 120. In some embodiments, the user device 115-1 is configured to receive the at least one real-time user input corresponding to and based on a type of the user device GUI 435 provided on the user device display unit 430. Non-limiting examples of the type of user device GUI 435 include an artificial intelligence-based chat interface, an artificial intelligence-based voice assistant related interface, an online collaboration communication and platform interface, a content management system interface, a search engine interface, a media player interface, a website interface, and a screen-reading interface. As an example, the user device 115-1 is configured to receive a text, an image, a video, and/or an audio query as the user input corresponding to the search engine interface. In some embodiments, the user device 115-1 is configured to provide the at least one received real-time input to the server 110 via the user device transceiver 410 and the network 125. In some embodiments, the user device 115-1 is also configured to receive, via the user device transceiver 410 and the network 125, the at least one generated and/or identified contextual response and/or content from the server 110. In some embodiments, user device 115-1 is also configured to receive, via the server 110, the one or more instructions to manipulate the user device GUI 435 to provide the at least one generated and/or identified contextual response and/or content based on at least one real-time received input. In some embodiments, the user device 115-1 is configured to provide the at least one received contextual response and/or content from the server 110 via the user output device 135-1 and/or the user audio input and/or output device 440. In some embodiments, the user device 115-1 is configured to provide the at least one received contextual response and/or content from the server 110 on the user device GUI 435 and/or the manipulated user device GUI 435. In some embodiments, the user device 115-1 is configured to provide the at least one received contextual response and/or content from the server 110 on the manipulated user device GUI 435 and the user audio input and/or output device 440 simultaneously. For example, the user device 115-1 is configured to provide the at least one received contextual response and/or content corresponding to text, video, and/or animation via the user device GUI 435 and/or the manipulated user device GUI 435 and provide the at least one received contextual response and/or content corresponding to audio response and/or content via the user audio input and/or output device 440. In some embodiments, the user device 115-1 is configured to continuously receive the real-time inputs via the user input device 130-1 and/or the input device(s) 120 and provide the at least one received contextual response and/or content via the manipulated user device GUI 435 and/or the user audio input and/or output device 440 in real-time.

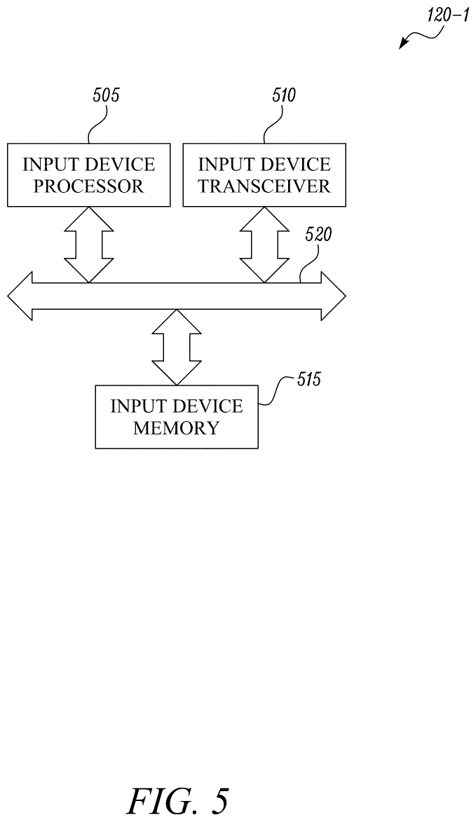

Referring to FIG. 5, a block diagram of exemplary input device 120-1 of the input device(s) 120 in communication with the user device(s) 115 (see FIG. 1) and/or the server 110 (see FIG. 1) is disclosed. It should be appreciated by those of ordinary skill in the art that FIG. 5 depicts the input device 120-1 in a simplified manner and a practical embodiment includes additional components and suitably configured logic to support known or conventional operating features that are not described in detail herein. Although the components of the input device 120-1 are illustrated and described to be implemented within the input device 120-1, it is contemplated that the one or more components of the input device 120-1 can alternatively be implemented in a distributed computing environment and/or implemented to be in remote and/or retrofitted communication with the input device 120-1. In some embodiments, one or more components of the user input device(s) 130 are also included in the input device 120-1, and/or one or more components of the input device 120-1 are included in the user input device(s) 130 of the user device(s) 115.

The input device 120-1 includes, among other components, an input device processor 505, an input device transceiver 510, and an input device memory 515. The components of the input device 120-1, including the input device processor 505, the input device transceiver 510, and the input device memory 515, cooperate with one another to enable operations of the input device 120-1. The components of the input device 120-1, for example 505, 510, 515, are communicatively coupled via an input device local interface 520. The input device local interface 520 includes, for example, but is not limited to, one or more buses or other wired or wireless connections, as is now known in the art or in the future developed. In an embodiment, input device local interface 520 has additional elements, which are omitted for simplicity, such as controllers, buffers (caches), drivers, repeaters, and receivers, among many others, to enable communications. Further, in some embodiments, the input device local interface 520 includes address, control, and/or data connections to enable appropriate communications among the aforementioned components.

As illustrated, the input device 120-1 includes the input device transceiver 510 to transmit one or more inputs to and receive one or more outputs from one or more other devices including, but not limited to, the server 110 and the user device(s) 115 via the network 125. The input device transceiver 510 includes a transmitter circuitry and a receiver circuitry to enable the input device 120-1 to communicate with the one or more other devices. In this regard, the transmitter circuitry includes appropriate circuitry to transmit the one or more inputs to the one or more other devices, and the receiver circuitry includes appropriate circuitry to receive the one or more outputs from the one or more other devices. It will be appreciated by those of ordinary skill in the art that the input device 120-1 includes a single input device transceiver 510 as illustrated, or alternatively separate transmitting and receiving components, for example but not limited to, a transmitter, a transmitting antenna, a receiver, and a receiving antenna.

The input device memory 515 is a non-transitory memory configured to store a set of instructions that are executable by the input device processor 505 to perform predetermined operations. For example, the input device memory 515 includes any of the volatile memory elements (for example, random access memory (RAM)), non-volatile memory elements (for example, read only memory (ROM)), and combinations thereof. Moreover, the input device memory 515 incorporates electronic, magnetic, optical, and/or other types of storage media.

The input device processor 505 is configured to execute the instructions stored in the input device memory 515 to perform the predetermined operations. The input device processor 505 includes one or more microprocessors, microcontrollers, DSPs (digital signal processors), state machines, logic circuitry, or any other device or devices that process information or signals based on operational or programming instructions. The input device processor 505 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The input device processor 505 is configured to cooperate with other components of the input device 120-1 to perform different operations described hereinafter.

In accordance with various embodiments, the input device 120-1 is configured to monitor a user and/or capture at least one real-time user input. In some embodiments, the input device 120-1 is configured to receive at least one real-time user input corresponding to the user device(s) 115 (see FIG. 1), the user interface, for example, the user device GUI 435 (see FIG. 4) provided on the user device(s) 115, for example, 115-1 and/or a user interface provided on the output device(s) 140 (see FIG. 1). In some embodiments, the input device 120-1 is configured to capture the at least one real-time user input in one or more formats including, but not limited to, an image, an audio, a video, an Augmented Reality (AR), a Virtual Reality (VR), a Mixed Reality (MR), an Extended Reality (XR), and/or an audio-visual format. For example, the input device 120-1 is configured to capture one or more audio inputs, text inputs, images, and/or videos. In accordance with various embodiments, the input device 120-1 is configured to provide, via the input device transceiver 510 and the network 125, the at least one captured real-time input to the server 110 and/or the user device(s) 115 via the network 125.

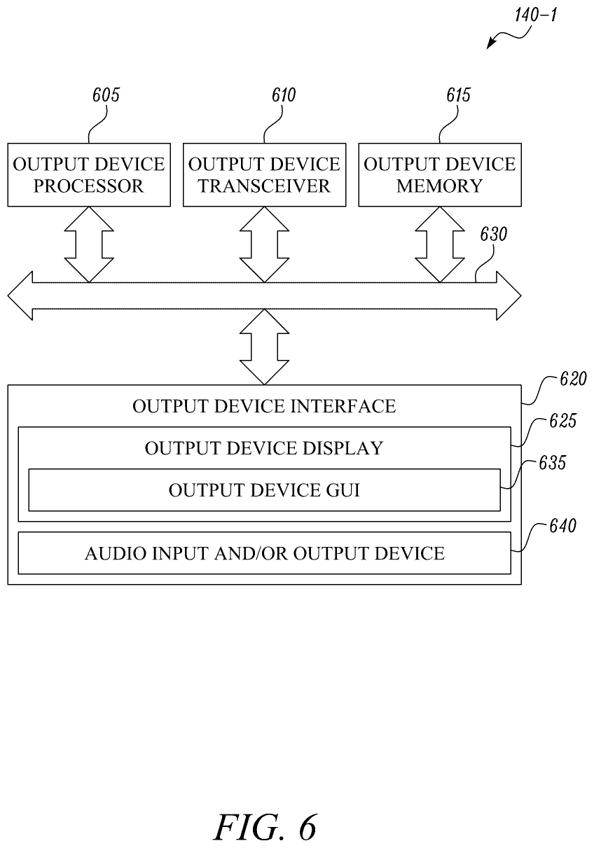

Referring to FIG. 6, the output device 140-1 of the output device(s) 140 (see FIG. 1) in communication with the user device(s) 115 and/or the server 110 via the network 125 (see FIG. 1) is disclosed. The output device 140-1 includes, among other components, an output device processor 605, an output device transceiver 610, an output device memory 615, an output device interface 620, an output device display 625, and an audio input and/or output device 640. In some embodiments, one or more components of the user output device(s) 135 are also included in the output device 140-1, and/or one or more components of the output device 140-1 are included in the user output device(s) 135 of the user device(s) 115. The components of the output device 140-1, including the output device processor 605, the output device transceiver 610, the output device memory 615, the output device interface 620, the output device display 625, and the audio input and/or output device 640 cooperate with one another to enable operations of the output device 140-1. The components of the output device 140-1, for example 605, 610, 615, 620, 625, 640 are communicatively coupled via an output device local interface 630. The output device local interface 630 includes, for example, but is not limited to, one or more buses or other wired or wireless connections, as is now known in the art or in the future developed. In an embodiment, output device local interface 630 has additional elements, which are omitted for simplicity, such as controllers, buffers (caches), drivers, repeaters, and receivers, among many others, to enable communications. Further, in some embodiments, the output device local interface 630 includes address, control, and/or data connections to enable appropriate communications among the aforementioned components.

As illustrated, the output device 140-1 includes the output device transceiver 610 to transmit one or more inputs to and receive one or more outputs from one or more other devices including, but not limited to, the user device(s) 115 and/or the server 110. The output device transceiver 610 includes a transmitter circuitry and a receiver circuitry to enable the output device 140-1 to communicate with the one or more other devices. In this regard, the transmitter circuitry includes appropriate circuitry to transmit the one or more inputs to the one or more other devices, and the receiver circuitry includes appropriate circuitry to receive the one or more outputs from the one or more other devices. It will be appreciated by those of ordinary skill in the art that the output device 140-1 includes a single output device transceiver 610 as illustrated, or alternatively separate transmitting and receiving components, for example but not limited to, a transmitter, a transmitting antenna, a receiver, and a receiving antenna.

In accordance with some embodiments, the output device display 625 includes an output device graphical user interface (GUI) 635 through which the user communicates with the user device(s) 115, one or more of the other output device(s) 140, and/or the server 110. The output device GUI 635 is an application or a web portal or any other suitable interface for accessing and/or displaying outputs received from the server 110, one or more of the other output device(s) 140, and/or the user device(s) 115. The output device GUI 635 includes one or more of graphical elements including, but not limited to one or more of dialogue boxes, window, web forms, text input field, microphone button, camera button, file upload button, text output display window, audio player, image/video display window, and/or the like.

The output device display 625 is configured to display text, images, videos, numbers, infographics, charts, diagrams, motion graphics, typography, dialogue boxes, window, web forms, text input field, microphone button, camera button, file upload button, text output display window, audio player, image/video display window, and other graphical elements now known or developed in future. The output device display 625 includes a display screen, a head-mounted display, or a computer monitor now known or in the future developed. In accordance with some embodiments, the output device display 625 is configured to display on the output device GUI 635 the outputs received from the one or more other devices.

In accordance with some embodiments, the audio input and/or output device, for example, 640 including, but not limited to, a microphone and speaker device, is configured to receive one or more audio inputs including, but not limited to, one or more voice inputs and environmental sound inputs, and provide one or more audio outputs including, but not limited to, one or more voice outputs, sounds, alerts, and alarms. In some embodiments, the audio input and/or output device, for example, 640 also includes an audio input and/or output port configured to accommodate a corresponding audio input and/or output plug associated with the microphone and speaker device for example, a wired earphone with microphone, to receive and provide the one or more audio inputs and the one or more audio outputs respectively. In some embodiments, the audio input and/or output device, for example, 640 also includes an external device, for example, a Bluetooth® microphone and speaker device in wireless communication with the output device interface 620 via the network 125 (see FIG. 1).

The output device memory 615 is a non-transitory memory configured to store a set of instructions that are executable by the output device processor 605 to perform predetermined operations. For example, the output device memory 615 includes any of the volatile memory elements (for example, random access memory (RAM)), non-volatile memory elements (for example, read only memory (ROM), and combinations thereof. Moreover, the output device memory 615 incorporates electronic, magnetic, optical, and/or other types of storage media.

The output device processor 605 is configured to execute the instructions stored in the output device memory 615 to perform the predetermined operations. The output device processor 605 includes one or more microprocessors, microcontrollers, DSPs (digital signal processors), state machines, logic circuitry, or any other device or devices that process information or signals based on operational or programming instructions. The output device processor 605 is implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The output device processor 605 is configured to cooperate with other components of the output device 140-1 to perform different operations described hereinafter. It will be apparent to those with ordinary skill in the art that the output device 140-1 is configured to perform similar functions as outlined above with reference to the user device 115-1. For example, the output device 140-1 is configured to receive the at least one real-time user input via the user input device 130-1 and/or the input device(s) 120. In some embodiments, the output device 140-1 is configured to receive the at least one real-time user input corresponding to and based on a type of the output device GUI 635 provided on the output device display 625 and/or the user device GUI 435 (see FIG. 4) provided on the user device display unit 430 (see FIG. 4). Non-limiting examples of the type of output device GUI 635 include an artificial intelligence-based chat interface, an artificial intelligence-based voice assistant related interface, an online collaboration communication and platform interface, a content management system interface, a search engine interface, a media player interface, a website interface, and a screen-reading interface. As an example, the output device 140-1 is configured to receive a text or audio query as the user input corresponding to the search engine interface provided on the user device GUI 435 and/or the output device GUI 635. In some embodiments, the output device 140-1 is configured to provide the at least one received real-time input to the user device(s), for example, the user device 115-1 (se FIG. 4) and/or directly to the server 110 via the user device transceiver 410 and the network 125. In some embodiments, the output device 140-1 is also configured to receive, via the user device transceiver 410 and the network 125, the at least one generated and/or identified contextual response and/or content from the user device(s) 115, for example, the user device 115-1 and/or the server 110. In some embodiments, the output device 140-1 is also configured to receive, via the user device(s) 115, for example, 115-1 or the server 110, one or more instructions to manipulate the output device GUI 635 to provide the at least one generated and/or identified contextual response and/or content based on at least one real-time received input. In some embodiments, the output device 140-1 is configured to provide the at least one received contextual response and/or content via the output device display 625 and/or the audio input and/or output device 640. In some embodiments, the output device 140-1 is configured to provide the at least one received contextual response and/or content on the output device GUI 635 and/or the manipulated output device GUI 635. In some embodiments, the output device 140-1 is configured to provide the at least one received contextual response and/or content on the manipulated output device GUI 635 and the audio input and/or output device 640 simultaneously. For example, the output device 140-1 is configured to provide the at least one received contextual response and/or content corresponding to text, video, and/or animation via the output device GUI 635 and/or the manipulated output device GUI 635 and provide the at least one received contextual response and/or content corresponding to audio response and/or content via the audio input and/or output device 640. In some embodiments, the output device 140-1 is configured to continuously receive the at least one real-time input via the user input device 130-1 and/or the input device(s) 120 and provide the at least one received contextual response and/or content received from the user device(s) 115 or the server 110 via the manipulated output device GUI 635 and/or the audio input and/or output device 640 in real-time.

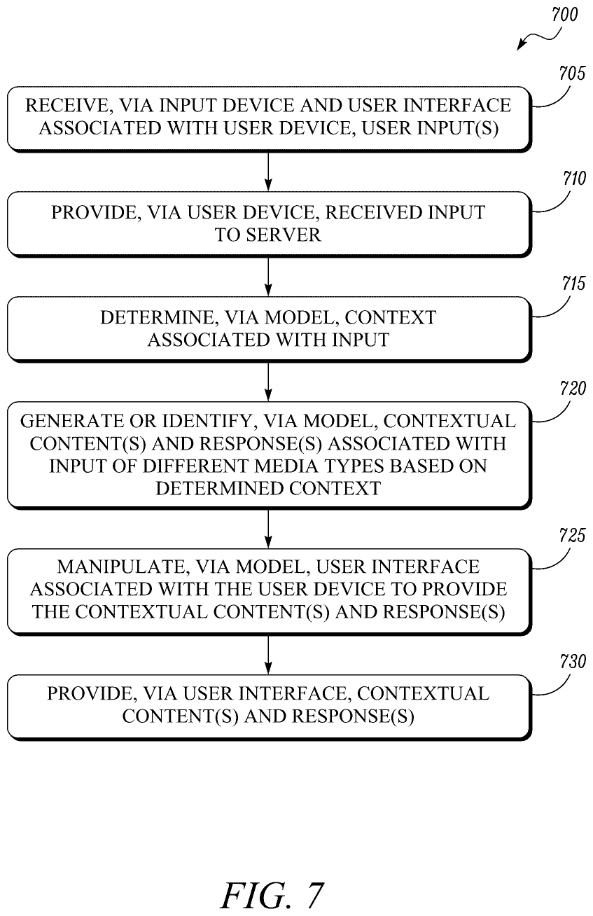

Referring to FIG. 7, a method 700, implemented by the system 105 of FIG. 1, for contextual content delivery is disclosed. At 705, the user device, for example, 115-1 (see FIGS. 1 and 4) and/or the output device 140-1 receives, via the user input device 130-1 and/or the input device(s) 120, at least one user input corresponding to a contextually aware user interface, for example, the user device GUI 435 (see FIG. 4) and/or the output device GUI 635 (see FIG. 6), provided by the server 110 on the user device(s), for example, 115-1 and/or the output device, for example, 140-1. At 710, the user device, for example, 115-1 provides, via the user device transceiver 410 (see FIG. 4), the at least one received input to the server 110 (see FIG. 1). At 715, the server 110 determines, via the model(s) 225 (see FIG. 2), a context associated with at least one user input. At 720, the server 110 generates and/or identifies, via the model(s) 225, at least one contextual content and response associated with the at least one received input of different media types respectively based on the determined context. At 725, the server 110 manipulates, via the model(s) 225, the contextually aware user interface, for example, the user device GUI 435 (see FIG. 4) of the user device 115-1 and/or the output device GUI 635 (see FIG. 6) of the output device, for example, 140-1 to provide the at least one generated response and the at least one identified contextual content. At 730, the server 110 provides, via the manipulated user interface, for example, the manipulated user device GUI 435 and/or the manipulated output device GUI 635, the at least one generated and/or identified contextual content and response.

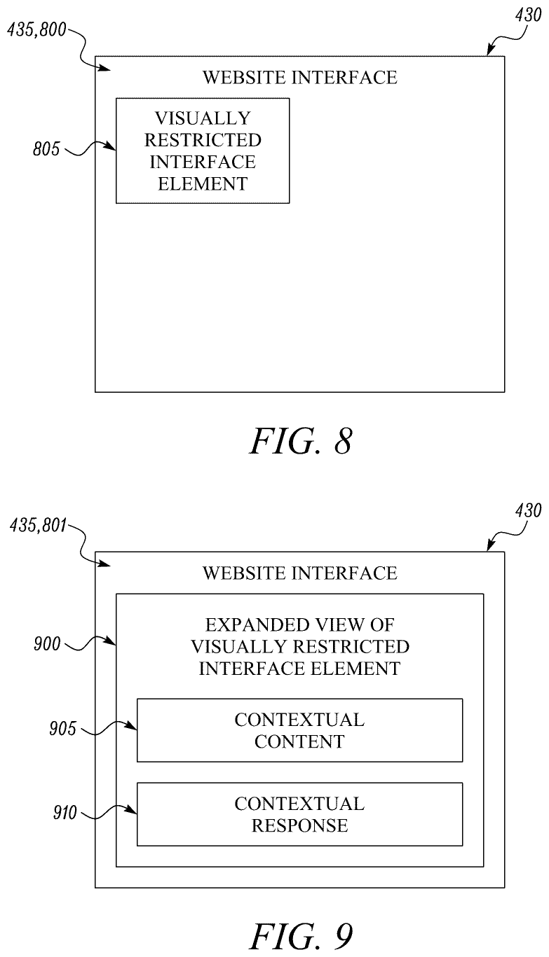

Referring to FIGS. 8 and 9, an illustration of an exemplary graphical user interface, for example, the user device GUI 435 (see FIG. 4) provided on the user device display unit 430 is disclosed. The exemplary graphical user interface, for example, the user device GUI 435 as illustrated corresponds to a website interface 800 associated with a website provided on the user device, for example, 115-1 (see FIGS. 1 and 4) is disclosed. The website interface 800 includes a visually restricted interface element 805. The visually restricted interface element 805 corresponds to an icon, a link, an image, a text, a button, or any other user interface element now known or in future developed. The user device 115-1 is configured to receive one or more user input, for example, a selection, a mouse click, a text input and/or a touchscreen input corresponding to the visually restricted interface element 805 via the user input device 130-1 (see FIG. 4) corresponding to the mouse, the keyboard, and/or the user device display unit 430. The user device 115-1 is configured to provide the received user inputs corresponding to the visually restricted interface element 805 to the server 110 via the network 125. The server 110 (see FIG. 1) is configured to determine the context of the received user inputs corresponding to the visually restricted interface element 805. The server 110 is also configured to generate and/or identify a contextual content 905 and a contextual response 910 of different media types, for example, an image/video and text respectively based on the determined context. The server 110 is also configured to generate instructions to manipulate the website interface 800 provided on the user device 115-1 to provide the contextual content 905 and the contextual response 910. The server 110 is then configured to provide the contextual content 905, the contextual response 910, and the generated instructions to manipulate the website interface 800 to the user device 115-1 via the network 125. The user device 115-1 is configured to manipulate the website interface 800 based on the received instructions from the server 110 by, for example, manipulating one or more back-end documents/files including, but not limited to, one or more Hypertext Markup Language (HTML) and/or Cascading Style Sheets (CSS) files/documents associated with the website interface 800. Based on the manipulation, the user device 115-1 is configured to provide an expanded view 900 of the visually restricted element 805 including the received contextual content 905 and the received contextual response 910 at different visual portions of same or different visual sizes within the expanded view 900 on the manipulated website interface 801 respectively. The user device 115-1 is also configured to synchronize the display of the received contextual content 905 with the display of the received contextual response 910, or the display of the received contextual response 910 with the display of the received contextual content 905 in the expanded view 900. For example, the user device 115-1 is configured to provide the contextual content 905 corresponding to a video stream on the manipulated website interface 801 and synchronize the display of the contextual response 910 corresponding to the text such as a transcript associated with the video stream in real-time. As another example, the user device 115-1 is configured to provide the contextual response 910 corresponding to text input on the manipulated website interface 801 and synchronize the display of the contextual content 910 corresponding to the image/video in real-time.

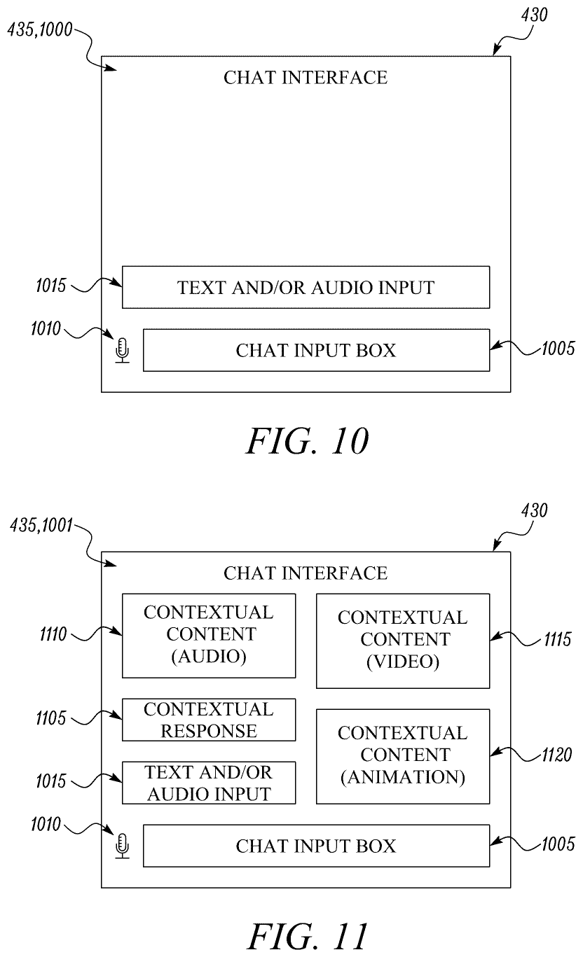

Referring to FIGS. 10 and 11, an illustration of another exemplary graphical user interface, for example, the user device GUI 435 (see FIG. 4) provided on the user device display unit 430 is disclosed. The exemplary graphical user interface, for example, the user device GUI 435 as illustrated corresponds to a web/online chat interface 1000 provided on the user device, for example, 115-1 (see FIGS. 1 and 4) is disclosed. The web/online chat interface 1000 includes a chat input box 1005 and an audio input icon 1010. The user device 115-1 is configured to receive one or more user input, for example, a text and/or an audio input 1015 corresponding to the chat input box 1005 and/or an audio input icon 1010 via the user input device 130-1 (see FIG. 4), corresponding to the mouse, the keyboard, the user device display unit 430, and/or the microphone. The user device 115-1 is configured to receive both the text and/or audio input 1015 simultaneously or sequentially with respect to each other. The user device 115-1 is configured to provide the received text and/or audio input(s) 1015 to the server 110 via the network 125. The server 110 (see FIG. 1) is configured to determine the context of the received text and/or audio input(s) 1015. The server 110 is also configured to generate and/or identify a contextual response 1105 corresponding to a text response/transcript and contextual contents 1110, 1115, 1120 of different media types, for example, an audio, video, and animation respectively based on the determined context. The server 110 is also configured to generate instructions to manipulate the web/online chat interface 1000 provided on the user device 115-1 to provide the contextual response 1105 and the contextual contents 1110, 1115, 1120. The server 110 is then configured to provide the contextual response 1105 and the contextual contents 1110, 1115, 1120, and the generated instructions to manipulate the web/online chat interface 1000 to the user device 115-1 via the network 125. The user device 115-1 is configured to manipulate the web/online chat interface 1000 based on the received instructions from the server 110 by, for example, manipulating one or more back-end documents/files including, but not limited to, one or more Hypertext Markup Language (HTML) and/or Cascading Style Sheets (CSS) files/documents associated with the web/online chat interface 1000. Based on the manipulation, the user device 115-1 is configured to provide the received contextual response 1105 and the received contextual contents 1110, 1115, 1120 at different visual portions of same or different visual sizes on the manipulated web/online chat interface 1001 respectively. The server 110 is configured to synchronize the display of the received contextual response 1105 and the received contextual contents 1110, 1115, 1120 with respect to each other on the manipulated web/online chat interface 1001 based on the response data, the content data, and/or the determined correlation therebetween associated with the received contextual response 1105 and the received contextual contents 1110, 1115, 1120. For example, the user device 115-1 is configured to provide the contextual content 1115 corresponding to a video stream on the manipulated web/online chat interface 1001 and synchronize a display of the contextual response 1105 corresponding to the text such as a transcript, an output of the contextual content 1110 corresponding to audio stream, and a display of the contextual content 1120 corresponding to the animation with the video stream in real-time. Similarly, different variations of the synchronization between the received contextual response 1105 and the received contextual contents 1110, 1115, 1120 are also contemplated.

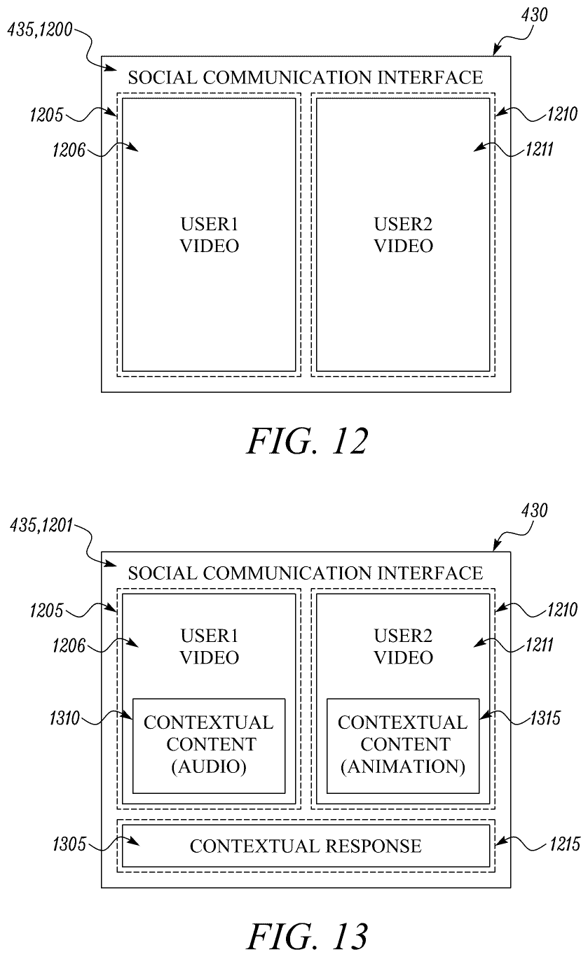

Referring to FIGS. 12 and 13, an illustration of an exemplary graphical user interface, for example, the user device GUI 435 (see FIG. 4) provided on the user device display unit 430 is disclosed. The exemplary graphical user interface, for example, the user device GUI 435 as illustrated corresponds to a social communication interface 1200 provided on the user device, for example, 115-1 (see FIGS. 1 and 4). The social communication interface 1200 includes visual portions 1205 and 1210 for displaying a video 1206 of a user interacting with the user device 115-1 and another video 1211 of another user operating another user device, for example, 115-2. The user device 115-1 is configured to receive a user input, for example, a video input via the user input device 130-1 (see FIG. 4) corresponding to the camera and display the received video, for example, 1206 in one of the visual portions, for example, 1205 based on received video input. The user device 115-1 is also configured to receive another user input, for example, the video input via another the user device, for example, 115-2 and the network 125 (see FIG. 1) and display the other received video, for example, 1211 in an another of the visual portions, for example, 1210 based on the other video input. The user device 115-1 is also configured to provide the received video inputs from the user devices 115-1, 115-2 and displayed in the visual portions 1205, 1210 respectively to the server 110 via the network 125. The server 110 (see FIG. 1) is configured to determine the context of the video inputs received. The server 110 is also configured to generate and/or identify a contextual response 1305 corresponding to a text response/transcript and contextual contents 1310, 1315 of different media types, for example, an audio and animation respectively based on the determined context. The server 110 is also configured to generate instructions to manipulate the social communication interface 1200 provided on the user device 115-1 to provide the contextual response 1305 and the contextual contents 1310, 1315. The server 110 is then configured to provide the contextual response 1305, the contextual contents 1310, 1315 and the generated instructions to manipulate the social communication interface 1200 to the user device 115-1 via the network 125. The user device 115-1 is configured to manipulate the social communication interface 1200 based on the received instructions from the server 110 by, for example, manipulating one or more back-end documents/files including, but not limited to, one or more Hypertext Markup Language (HTML) and/or Cascading Style Sheets (CSS) files/documents associated with the social communication interface 1200. Based on the manipulation, the user device 115-1 is configured to provide the received contextual response 1305 in another visual portion 1215 independent of the visual portions 1205, 1210 and the received contextual contents 1310, 1315 as an overlay at different visual portions of same or different visual sizes respectively within the visual portions 1205, 1210 on the manipulated social communication interface 1201. The user device 115-1 is also configured to synchronize the display of the received contextual response 1305 and the received contextual contents 1310, 1315 with respect to each other. For example, the user device 115-1 is configured to provide the contextual response 1305 corresponding to the text response on the manipulated social communication interface 1201 and synchronize the display of the contextual contents 1310, 1315 corresponding to the audio and animation respectively in real-time. As another example, the user device 115-1 is configured to provide the contextual contents 1310, 1315 corresponding to the audio and the animation on the manipulated social communication interface 1201 and synchronize the display of the contextual response 1305 corresponding to text such as a transcript associated with the contextual contents 1310, 1315 and/or the video(s), for example, 1206, 1211 displayed in the visual portions 1205, 1210 in real-time.

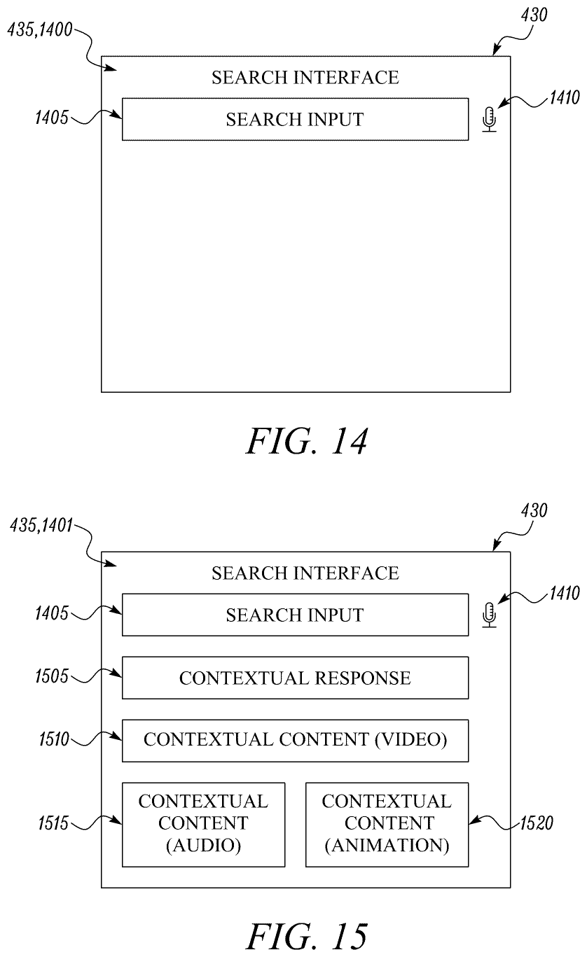

Referring to FIGS. 14 and 15, an illustration of another exemplary graphical user interface, for example, the user device GUI 435 (see FIG. 4) provided on the user device display unit 430 is disclosed. The exemplary graphical user interface, for example, the user device GUI 435 as illustrated corresponds to a search interface 1400 provided on the user device, for example, 115-1 (see FIGS. 1 and 4) is disclosed. The search interface 1400 includes a search input box 1405 and an audio input icon 1410. The user device 115-1 is configured to receive one or more user input, for example, a text and/or an audio input corresponding to the search input box 1405 and/or the audio input icon 1410 via the user input device 130-1 (see FIG. 4) corresponding to the mouse, the keyboard, the user device display unit 430, and/or the microphone. The user device 115-1 is configured to receive both the text and audio input simultaneously or sequentially with respect to each other. The user device 115-1 is configured to provide the received text and/or audio inputs to the server 110 via the network 125. The server 110 (see FIG. 1) is configured to determine the context of the received text and/or audio inputs. The server 110 is also configured to generate and/or identify a contextual response 1505 corresponding to a text response/transcript and contextual contents 1510, 1515, 1520 of different media types, for example, an audio, video, and animation respectively based on the determined context. The server 110 is also configured to generate instructions to manipulate the search interface 1400 provided on the user device 115-1 to provide the contextual response 1505 and the contextual contents 1510, 1515, 1520. The server 110 is then configured to provide the contextual response 1505 and the contextual contents 1510, 1515, 1520, and the generated instructions to manipulate the search interface 1400 to the user device 115-1 via the network 125. The user device 115-1 is configured to manipulate the search interface 1400 based on the received instructions from the server 110 by, for example, manipulating one or more back-end documents/files including, but not limited to, one or more Hypertext Markup Language (HTML) and/or Cascading Style Sheets (CSS) files/documents associated with the search interface 1400. Based on the manipulation, the user device 115-1 is configured to provide the received contextual response 1505 and the received contextual contents 1510, 1515, 1520 at different visual portions of same or different visual sizes on the manipulated search interface 1401 respectively. The server 110 is configured to synchronize the display of the received contextual response 1505 and the received contextual contents 1510, 1515, 1520 with respect to each other on the manipulated search interface 1401 based on the response data, the content data, and/or the determined correlation therebetween associated with the received contextual response 1505 and the received contextual contents 1510, 1515, 1520. For example, the user device 115-1 is configured to provide the contextual content 1515 corresponding to a video stream on the manipulated search interface 1401 and synchronize a display of the contextual response 1505 corresponding to the text such as a transcript, an output of the contextual content 1510 corresponding to audio stream, and a display of the contextual content 1520 corresponding to the animation with the video stream in real-time. Similarly, different variations of the synchronization between the received contextual response 1505 and the received contextual contents 1510, 1515, 1520 are also contemplated.

It is apparent, in view of the above, that the system 105 and the method 700 of the present disclosure provide an interactive and contextually aware user interface that is capable of establishing a real-time bi-directional contextual communication between the user device(s) 115 and the server 110 and continuously providing the at least one generated or identified contextual content and/or response corresponding to each user input received from the input device(s) 120 and/or the user input device(s) 130. Further, the system 105 and the method 700 of the present disclosure, by means of the contextually aware user interface and the contextual content(s) and response(s) provided on the contextually aware user interface provide an improved alternative to conventional user interfaces including, but not limited to, Windows, Icons, Menus, and Pointer (WIMP) interface elements. In particular, the system 105 and the method 700 of the present disclosure, by means of the contextually aware user interface and the contextual content(s) and response(s) provided on the contextually aware user interface reduce significant time, processing requirements, and/or storage requirements of the server 110 and/or the user device(s) 115. For example, the system 105 and the method 700 of the present disclosure, by means of the contextually aware user interface, enable retrieving and/or providing the generated contextual response and/or content, and/or access to a plurality of user interface related elements, documents, files, webpages, and any other interface-related information on-demand and/or only in response to the determined user interaction event or user input in a simplified manner rather than provide an entirety of content that is both related and unrelated to the determined user interaction event or user input each time as is typically provided on conventional user interfaces such as webpages including, but not limited to, multiple text, image, and/or video contents in addition to the WIMP interface elements. The server 110 therefore requires lesser processing resources for the on-demand delivery of the contextual response and content requires in comparison to having to provide the entirety of content(s) (e.g. web content) by default on the conventional user interfaces. The user device(s) 115 also receives specific contextual response and/or content(s) from the server 110, thereby reducing storage requirements of the user device(s) 115 and the processing resources to be assigned for providing the contextually aware user interface with the contextual response and/or content(s) rather than the entirety of the content(s) (e.g. web content) by default on the conventional user interfaces. For example, a conventional user interface for a website such as car manufacturer's website includes multiple windows, menus, icons, and pointers or action buttons to enable a user to access information associated with one or more cars. In such websites, the user, typically, tends to navigate multiple windows, menus, icons, and pointers to obtain the information related to a specific car sought by the user. In comparison, the system 105 and the method 700 of the present disclosure, by means of the contextually aware user interface, enable the user to directly provide a user input, for example, a query corresponding to the website interface to obtain the information related to a specific car and obtain contextual content(s) and response(s) including, but not limited to, a combination of text description including technical information, images, and/or videos associated with the specific car on the contextually aware user interface, thereby minimizing time taken to obtain the specific information and improving user experience.

Furthermore, the system 105 and the method 700 of the present disclosure also enable continuous manipulation of the contextually aware user interface such that contextual content(s) and response(s) are provided on the user device(s) 115 in an interactive and engaging manner. Moreover, the system 105 and the method 700 of the present disclosure also enable synchronization of the contextual content(s) and response(s) provided on the user device(s) 115, thereby significantly improving user experience and understanding of the information provided on the contextually aware user interface. In comparison, the conventional user interfaces tend to provide static and/or limited information and/or responses in response to the user inputs based on the prestored data. Furthermore, the conventional user interfaces are also static interfaces, in that, a structure of the static interfaces is generally fixed and any reconstruction of the static interfaces potentially results in misplacement and/or misalignment issues in respect of the user interface elements presented on the conventional user interfaces. The system 105 and the method 700 of the present disclosure overcome such issues associated with the conventional user interfaces by means of the contextually aware user interface that dynamically adjusts a position, a size, and/or a time duration of display of the contextual content(s) and response(s) on the contextually aware user interface. The system 105 and the method 700 of the present disclosure also enable real-time and continuous detection of user input(s) during communication between users on different user devices, for example, 115-1 . . . 115-n such that relevant and useful the contextual content(s) and response(s) associated with the detected user input(s) can also be provided via the contextually aware interface in real-time by continuously determining the context of the user input(s) in real-time and correspondingly manipulating the contextually aware user interface to provide the contextual content(s) and response(s). Moreover, the system 105 and the method 700 of the present disclosure also enable automatic selection and/or execution of contextually relevant applications, programs, and/or functions in real-time by the server 110 based on the determined context of the user interaction event(s) and/or input(s), thereby intelligently understanding and managing one or more complex actions to be performed in response to and/or corresponding to the user interaction event(s) and/or input(s). For example, the system 105 and the method 700 of the present disclosure enable the server 110 to access, execute, and/or perform one or more actions associated with one or more Software-as-a-Service (SaaS) applications including, but not limited to, Human Capital Management (HCM) systems, Human Resources Management Systems (HRMS), and Human Resources Information Systems (HRIS), in response to the one or more user input(s) received via the contextually aware user interface provided on the user device(s) 115.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that can cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, front and rear, and the like can be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but can include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but can also be configured in ways that are not listed.

It will be appreciated that some embodiments can be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. An artificial intelligence-based system for contextual content delivery, comprising:
at least one input device;
at least one user device; and
a server in communication with the at least one input device and the at least one user device, wherein the server comprises a processor and a memory for storing instructions, that when executed by the processor, causes the server to:
provide, via the at least one user device, a contextually aware user interface;
determine, via the at least one input device, at least one user interaction event corresponding to the contextually aware user interface;
determine, via at least one artificial intelligence model, a context associated with at least one determined user interaction event;
generate or identify, via the at least one artificial intelligence model, at least one contextual content and at least one contextual response associated with the at least one determined user interaction event based on the determined context, wherein a media type of the at least one generated or identified contextual content and response is different from each other;
manipulate, via the artificial intelligence model, the contextually aware user interface to provide the at least one generated or identified contextual content and response; and
provide, via the manipulated contextually aware user interface, the at least one generated or identified contextual content and response,
wherein the at least one user device is configured to:
detect, via the at least one input device, the at least one user interaction event corresponding to the contextually aware user interface;
provide, via a transceiver of the at least one user device, the at least one detected user interaction event to the server;
receive, via the server, the at least one generated or identified contextual content and response, and information associated with the manipulated contextually aware user interface; and
provide, via at least one output device of the at least one user device and the manipulated contextually aware user interface, the at least one generated or identified contextual content and response based on the received information associated with the manipulated contextually aware user interface.

2. The artificial intelligence-based system of claim 1, wherein the manipulation of the contextually aware user interface corresponds to a Document Object Model (DOM) manipulation.

3. The artificial intelligence-based system of claim 1, wherein the server is configured to:
provide, via the at least one output device of the at least one user device, at least one visually constrained interface element on the contextually aware user interface;
receive, via the at least one input device, at least one input corresponding to or associated with the at least one visually constrained interface element, wherein the at least one received input corresponds to the at least one determined interaction event;
determine, via at least one artificial intelligence model, the context associated with the at least one visually constrained interface element based on the at least one received input; and
manipulate, via the artificial intelligence model, the contextually aware user interface to provide at least one expanded view associated with the at least one visually constrained interface element, wherein the at least one expanded view comprises the at least one generated or identified contextual content.

4. The artificial intelligence-based system of claim 3, wherein the server is configured to provide, via the at least one output device of the at least one user device, the at least one expanded view as an overlay over the provided contextually aware user interface.

5. The artificial intelligence-based system of claim 1, wherein the server is configured to:
receive, via the at least one input device, at least one text input and at least one audio input in a natural language format, wherein the receipt of the at least one text input and the at least one audio input corresponds to the at least one determined interaction event; and
determine, via the at least one artificial intelligence model, the context associated with the at least one received text input and the at least one received audio input.

6. The artificial intelligence-based system of claim 5, wherein the server is configured to:
commence, via the at least one artificial intelligence model, an interactive session in response to the at least one received text input, the at least one received audio input, or a combination thereof; and
retain, via the at least one artificial intelligence model, the determined context associated with the at least one text input and the at least one audio input upon receipt of at least one subsequent text input, audio input, or a combination thereof during the commenced interactive session.

7. The artificial intelligence-based system of claim 1, wherein the server is configured to perform at least one action based on the determined context, the at least one action comprising:
send, via the at least one artificial intelligence model, an API request to at least one additional server;
execute, via the at least one artificial intelligence model, at least one contextual computer or program function, wherein the server is configured to:
identify, via the at least one artificial intelligence model, the at least one contextual computer or program function to be executed based on the determined context; or
any combination thereof.

8. The artificial intelligence-based system of claim 1, comprising at least one data repository, wherein the server is configured to:
store, via the processor, at least one master system prompt in at least one data repository, wherein the at least one master system prompt defines an expected behavior, an expected personality, or a combination thereof to be indicated via the at least one generated or identified contextual content and response by the at least one artificial intelligence model;
store, via the processor, at least one content or content module in the at least one data repository, wherein the at least one stored content is associated with at least one content identifier;
embed, via the processor, the at least one content identifier in the at least one master system prompt, wherein upon the determination of the at least one user interaction event and based on the determined context, the server is configured to:
fetch, via the processor, the at least one stored master system prompt;
parse, via the processor, the at least one stored master system prompt;
identify, via the processor, the at least one content identifier embedded in the at least one stored master system prompt;
retrieve, via the processor, the at least one content or content module associated with the at least one identified content identifier;
replace, via the processor, the at least one content identifier embedded in the at least one stored master system prompt with the at least one retrieved content or content module;
generate, via the processor, a run-time system prompt comprising the at least one master system prompt and the at least one retrieved content or content module included in the at least one master system prompt; and
provide, via the processor, the at least one run-time system prompt to the at least one artificial intelligence model, wherein the server is configured to generate or identify the at least one contextual content and response based on the at least one provided run-time system prompt, the at least one generated or identified contextual content and response being indicative of the expected behavior, an expected personality, or a combination thereof.

9. The artificial intelligence-based system of claim 8, wherein the server is configured to modify the at least one master system prompt by:
receiving, via the at least one input device, at least one alternative content or content module;
storing, via the processor, the at least one received alternative content or content module in the at least one data repository;
assigning, via the processor, the at least one content identifier corresponding to the at least one received alternative content or content module; and
replacing, via the processor, the at least one embedded content identifier in the at least one at least one master system prompt with the at least one assigned content identifier, wherein the at least one modified master system prompt based on the replacement is indicative of a user expected behavior, a user expected personality, or a combination thereof.

10. The artificial intelligence-based system of claim 1, wherein the memory comprises at least one network buffer, and server is configured to:
determine, via the processor, a network jitter based on the at least one determined user interaction event; and
dynamically adjust, via the processor, a network threshold, a buffer size, or a combination thereof associated with the at least one network buffer based on determined network jitter, wherein the buffer size is a function of the determined network jitter;
queue, via the processor, at least one data chunk associated with the at least one generated or identified contextual response, the at least one contextual content, or a combination thereof based on the determined network jitter, wherein the server is configured to adjust at least one parameter associated with the at least one data chunk based on determined network jitter, at least one historical network jitter pattern stored in at least one data repository, or a combination thereof; and
provide, via the processor, the at least one queued data chunk based on the dynamically adjusted network threshold.

11. The artificial intelligence-based system of claim 1, wherein the at least one user interaction event corresponds to at least one input received via the at least one input device, and the server is configured to:
identify, via the processor, at least one keyword in the at least one received input;
map, via the processor, the at least one identified keyword or a portion of the at least one identified keyword with at least one media tag associated with at least one database content stored in at least one data repository;
generate or identify, via the processor and the at least one artificial intelligence model, the at least one contextual content associated with the at least one receive input based on the mapping;
determine, via the processor and the at least one artificial intelligence model, a semantic correlation between the at least one generated or identified contextual content and the at least one received input,
determine, via the processor and the at least one artificial intelligence model, a relevance score based on the determined sematic correlation; and
identify, via the processor and the at least one artificial intelligence model, the at least one contextual content to be provided to the at least one user device based on the determined relevance score.

12. The artificial intelligence-based system of claim 11, wherein the server is configured to:
assign, via the at least one artificial intelligence model, a priority to a media type of the at least one determined contextual content, at least one historical user interaction event associated with the at least one determined user interaction event stored in the at least one data repository, or a combination thereof; and
provide, via the at least one output device of the at least one user device, the at least one identified contextual content based on the assigned priority.

13. The artificial intelligence-based system of claim 11, wherein the server is configured to:
synchronize, via the at least one artificial intelligence model, the providing of the at least one generated or identified contextual response and the at least one generated or identified contextual content on the at least one user device such that at least one response data included in the at least one provided response correlates with the at least one provided contextual content.

14. The artificial intelligence-based system of claim 1, wherein the server is configured to define a time duration of the providing of the at least one generated or identified contextual response, the at least one identified contextual content, or a combination thereof.

15. The artificial intelligence-based system of claim 1, wherein the at least one identified contextual content corresponds to a plurality of identified context contents, and the server is configured to:
provide, via the at least one artificial intelligence model and the at least one user device, the plurality of identified context contents arbitrarily, sequentially, or simultaneously based on at least one response data included in the at least one generated or identified contextual response.

16. The artificial intelligence-based system of claim 1, wherein the at least one identified contextual content comprises audio content, and the server is configured to:
provide, via the at least one artificial intelligence model and the at least one user device, the audio content as an audio stream and at least one partial transcript corresponding to a portion of the provided audio stream in real-time;
provide, via the at least one user device, a complete transcript of the provided audio stream; or a combination thereof.

17. The artificial intelligence-based system of claim 1, wherein the server is configured to:
manipulate, via the at least one artificial intelligence model, the contextually aware user interface such that the contextually aware user interface transitions from the at least one provided contextual content to at least one additional contextual content upon determination of at least one subsequent user interaction event via the at least one user device.

18. The artificial intelligence-based system of claim 1, wherein the contextually aware user interface corresponds to an artificial intelligence chat interface, an artificial intelligence voice assistant related interface, an online collaboration communication and platform, a content management system interface, a search engine interface, a media player interface, a website interface, or a screen-reading interface.

19. A method for contextual content delivery, comprising:
providing, via at least one user device, a contextually aware user interface;
determining, by a server via the at least one input device, at least one user interaction event corresponding to the contextually aware user interface;
determining, via at least one artificial intelligence model implemented by the server, a context associated with at least one determined user interaction event;
generating or identifying, via the at least one artificial intelligence model, at least one contextual content and at least one contextual response associated with the at least one determined user interaction event based on the determined context, wherein a media type of the at least one generated response and the at least one identified contextual content is different from each other;
manipulating, via the artificial intelligence model, the contextually aware user interface to provide the at least one generated or identified contextual content and response; and
providing, via the manipulated contextually aware user interface, the at least one generated or identified contextual content and response.

20. The method of claim 19, comprising:
providing, via the at least one user device, at least one visually constrained interface element on the contextually aware user interface;
receiving, via the at least one input device, at least one input corresponding to or associated with the at least one visually constrained interface element, wherein the at least one received input corresponds to the at least one determined interaction event;
determining, via at least one artificial intelligence model, the context associated with the at least one visually constrained interface element based on the at least one received input; and
manipulating, via the artificial intelligence model, the contextually aware user interface to provide at least one expanded view associated with the at least one visually constrained interface element, wherein the at least one expanded view comprises the at least one generated or identified contextual content and response, and the manipulation corresponds to a Document Object Model (DOM) manipulation of the contextually aware user interface.

21. The method of claim 19, comprising:
storing, via a processor of the server, at least one master system prompt in at least one data repository, wherein the at least one master system prompt defines an expected behavior, an expected personality, or a combination thereof to be indicated via the at least one generated or identified contextual content and response by the at least one artificial intelligence model;
storing, via the processor, at least one content or content module in the at least one data repository, wherein the at least one stored content is associated with at least one content identifier;
embedding, via the processor, the at least one content identifier in the at least one master system prompt, wherein upon the determination of the at least one user interaction event and based on the determined context, the method comprises:
fetching, via the processor, the at least one stored master system prompt;
parsing, via the processor, the at least one stored master system prompt;
identifying, via the processor, the at least one content identifier embedded in the at least one stored master system prompt;
retrieving, via the processor, the at least one content or content module associated with the at least one identified content identifier;
replacing, via the processor, the at least one content identifier embedded in the at least one stored master system prompt with the at least one retrieved content or content module;
generating, via the processor, a run-time system prompt comprising the at least one master system prompt and the at least one retrieved content or content module included in the at least one master system prompt; and
providing, via the processor, the at least one run-time system prompt to the at least one artificial intelligence model, wherein the server is configured to generate the at least one generated or identified contextual content and response based on the at least one provided run-time system prompt, the at least one generated or identified contextual content and response being indicative of the expected behavior, an expected personality, or a combination thereof.

22. The method of claim 19, comprising:
determining, via a processor of the server, a network jitter based on the at least one determined user interaction event; and
dynamically adjusting, via the processor, a network threshold, a buffer size, or a combination thereof associated with at least one network buffer of a memory provided in the server based on determined network jitter, wherein the buffer size is a function of the determined network jitter;
queuing, via the processor, at least one data chunk associated with the at least one generated or identified contextual response, the at least one contextual content, or a combination thereof based on the determined network jitter, wherein the server is configured to adjust at least one parameter associated with the at least one data chunk based on determined network jitter, at least one historical network jitter pattern stored in at least one data repository, or a combination thereof; and
providing, via the processor, the at least one queued data chunk based on the dynamically adjusted network threshold.

23. The method of claim 19, wherein the at least one user interaction event corresponds to at least one input received via the at least one input device, and the method comprises:
identifying, via a processor of the server, at least one keyword in the at least one received input;
mapping, via the processor, the at least one identified keyword or a portion of the at least one identified keyword with at least one media tag associated with at least one database content stored in at least one data repository;
determining, via the processor and the at least one artificial intelligence model, the at least one contextual content associated with the at least one receive input based on the mapping;
determining, via the processor and the at least one artificial intelligence model, a semantic correlation between the at least one determined contextual content and the at least one received input,
determining, via the processor and the at least one artificial intelligence model, a relevance score based in the determined sematic correlation; and
identifying, via the processor and the at least one artificial intelligence model, the at least one contextual content to be provided to the at least one user device based on the determined relevance score.
